(19) United States
(12) Patent Application Publication
(10) Pub. No.: US 2015/0269523 A1
(43) Pub. Date: Sep. 24, 2015

(54) COMPUTER SYSTEM FOR EXTRACTING AND CLUSTERING IP DOCUMENT INFORMATION AND FOR FURNISHING AN ONLINE QUOTE FOR REPLYING TO AN OUTSTANDING DEADLINE

(71) Applicant: IPV HOLDINGS LTD., Ottawa (CA)

(72) Inventor: Adebayo ODUTOLA, Ottawa (CA)

(21) Appl. No.: 14/660,364

(22) Filed: Mar. 17, 2015

(30) Foreign Application Priority Data
Mar. 18, 2014 (GB) 1404844.1

(51) Int. Cl. G06Q 10/10; G06F 17/30

(52) U.S. Cl. CPC G06Q 10/10; G06F 17/30598; G06F 17/30867; G06Q 50/184

(57) ABSTRACT

The invention relates to computer and machine generated systems communicating via a processor, for locating, monitoring, obtaining, displaying delivering with the use of a single or multiple identifier Madrid protocol and national office actions/refusals by country or jurisdiction, and calculating deadlines via a computing device linked to a computer system for requesting, comparing and providing agent costs to users specifically for agents to respond to a particular office action/refusal in particular country and or a particular case all with an interface adapted to receive, display and send Madrid protocol and national office messages to users and IP offices.

### CROSS REFERENCE TO RELATED APPLICATIONS

This application claims the benefit of priority of UK Patent Application No. 1404844.1 filed Mar. 18, 2014, which is hereby incorporated by reference.

### FIELD

The present disclosure relates to a computer implemented system for extracting, clustering and providing access with a unique identifier to IP information/documents in a searchable format and providing cost information relating to generation of work-products for identified IP documents.

### BACKGROUND

The Madrid Protocol system is an international system for facilitating the registration of trademarks in multiple jurisdictions around the world. More specifically, the Madrid Protocol system provides for the international registration of trade marks by way of one application that can cover more than one country. The advantage of having a single registration to cover a wide range of countries should simplify at least portfolio management while conferring cost savings, when compared to a portfolio of independent national registrations.

However in reality, the prosecution process is cumbersome and time inefficient with the existing tools available to the trademark owners and agents. The current trademark prosecution process is outlined in FIG. 1, and can generally be described as follows.

An international application is filed based on basic national registration or application from a Madrid member country (Office of Origin) such as the USA, designating one or more other Madrid Protocol Members (Designated Member) such as Japan, China etc. Once the international application is processed and examined by WIPO, it becomes an international registration and is granted an international registration number. Subsequently, WIPO then sends a request for national filing to the (Designated Members) without requiring a local agent for filing.

Each Designated Member's National IP Office then proceeds to a national examination, issues an office action (also known as a refusal), if applicable, (Designated Member's National Office Action) which is then forwarded by the Designated Member's National IP office to WIPO. WIPO in turn forwards the Designated Member's National Office Action to the representative of the International registration (WIPO Rep). Depending on the Office of Origin, forwarding of Designated Member's National Office Action is generally done by regular mail.

The WIPO Rep then receives Designated Member's National Office Action, consults applicant/client if applicable, and if client/applicant instructs, the WIPO Rep then seeks an agent in the Designated Member to respond, requests a quote and then sends instructions to local agent in Designated Member (Local Agent for Designated Member). Usually, the WIPO Rep does not send the Designated Member's National Office Action to several local agents with the same Designated Member since it is time consuming and not efficient.

Depending on the jurisdiction, the Designated Member has local power of attorney requirements (POA). Therefore the WIPO Rep must contact the client to obtain POA for the Local Agent for Designated Member. Sometimes, IP management software (IP Software) is used to inform the WIPO Rep that the Local Agent for Designated Member requires a POA. If a POA is required, the WIPO Rep prepares a POA that is sent to client/applicant for signature. Once the WIPO Rep receives the signed POA, it is sent to the Local Agent for Designated Member. This process is executed for just a single country for which an office action has been issued. If a different country issues an office action, then this process must be repeated. Accordingly, the WIPO Rep has to repeat the same process for each country designated under the Madrid Protocol that issues an office action.

The above mentioned process is simply an overview of the general process flow when an office action from a single country is received. However, the detailed activities undertaken by the WIPO Rep are far more cumbersome.

Since delivery of notification of office action or refusal from WIPO to the WIPO Rep is by ordinary mail, and any effective time for responding by an established due date is reduced. There is a time delay from WIPO to WIPO Rep to obtain the relevant document. While email communications is possible, email delivery of the Designated Member's National IP Office Action is secondary and mail delivery is time consuming for WIPO Rep. It requires the WIPO Rep or any user to take the following additional steps:
compile list by International Registration Number
receive email
Login to account
proceed through several tabs to find notification
to locate specific tab in which notifications are located
Calculate deadline
Download document

Furthermore, the current WIPO system is limited in two ways. First, a user is limited to using reliably only its international registration number (IRN) specified by the user for countries that fall within the WIPO jurisdiction and only if such countries have been designated under an international registration. Second, the WIPO system does not have nor does any other jurisdiction or system have a searchable centralized database providing access to office actions or refusals documents issued by the Designated Member's National IP Offices, non-Designated Members' Office Actions or both. For instance, any application filed under the Office for Harmonization of the Internal Market (OHIM) is limited to serial numbers specified by user within the OHIM jurisdiction and the documents issued by OHIM or WIPO relate to an OHIM application or registration. In the same way, the USPTO system is limited to providing USPTO office actions/refusals for national applications and for the Designated Member's National Office Actions. The USPTO system includes WIPO serial numbers for applications that have designated for instance the United States of America however, and one cannot search any other Designated Members National Office Actions, or Madrid Protocol based applications/registrations.

Even more cumbersome is the patent system, which currently provides no international patent at all. While a Patent Convention Treaty (PCT) application can be filed, the application must eventually be “entered” into each national and/or regional jurisdiction where patent rights will be sought. Prosecution of such regional/national phase entry applications then progresses independently in each of said national/regional jurisdictions. After exiting the international phase, each nation/region maintains their own database. There is no centralized database providing access to deadline related correspondence, such as Office Actions for all the jurisdictions.

Similar difficulties exist with other types of intellectual property, such as Designs, plant breeders' rights, . . . etc.

### SUMMARY OF THE INVENTION

The present invention provides users the ability to view a list of one or more of IP documents online and see the deadlines associated with such IP documents. In making a choice of a deadline, the user is presented with a choice of one or more agents authorized to act in the jurisdiction of the IP document having the deadline. Optionally, the user can add his/her own choice of agent. The system will then automatically obtain quotes from the selected agents and upon choosing an agent, the system will automatically instruct and bill the work.

In one aspect, the present invention provides a system for providing a user module at least one quote for responding to an intellectual property (IP)-related deadline, said system comprising a service module, the service module comprising: a data acquisition engine configured to communicate electronically with an IP office computer system in at least one jurisdiction and to automatically identify and extract IP-related information from said IP office computer system for multiple IP documents, wherein said IP-related information includes jurisdiction, serial number, and deadline-generating dates, and wherein said data acquisition engine automatically generates links to electronically accessible IP office correspondence having a reply deadline; a database clustering engine for processing the extracted IP-related information, said clustering engine automatically generating a sub-unique identifier to associate an IP document with a serial number, automatically generating an IP jurisdiction identifier to associate the IP document with a jurisdiction, automatically associate deadline-generating dates with the sub-unique identifier and the IP jurisdiction identifier for the corresponding IP document, and automatically associate a link to electronically accessible IP office correspondence having a reply deadline with the sub-unique identifier and the IP jurisdiction identifier for the corresponding IP document, a set of statements and instructions for deadline calculation, based on deadline-generating dates and jurisdiction associated therewith; a processor configured to: automatically execute said set of statements and instructions to calculate an upcoming deadline for each of said deadline-generating dates, automatically associate said deadline to said IP document and to said corresponding sub-unique identifier and jurisdiction identifier, and automatically determine the agent records having the agent jurisdiction identifier matching the IP jurisdiction identifier of said IP document, to generate a list of one or more agents in said jurisdiction; a mass storage device for storing a database comprising: said IP-related information, said deadlines, said links to IP office correspondence having a reply deadline, each IP office correspondence having a reply deadline being associated with (i) the sub-unique identifier, and (ii) the IP jurisdiction identifier, and agent records, each agent record including (iii) an agent jurisdiction identifier to identify the agent's jurisdiction; a search engine configured to: receive an input from said user module, in response to said input, automatically retrieve the IP-related information, the link to IP office correspondence having a reply deadline, and said corresponding deadline(s), associated with one or more corresponding sub-unique identifiers, and automatically retrieve the generated list of one or more agents in said jurisdiction corresponding to said agent jurisdiction identifiers; communication means, configured to communicate electronically with one or more agent modules and a user module, the communication means configured to: in response to said input, automatically display on the user module, the IP-related information, the deadlines, and the link to IP office correspondence having a reply deadline, retrieved by the search engine, and said deadline(s) calculated by the processor, and automatically display on the user module, the generated list of one or more agents in said jurisdiction, receive a selection of a deadline from a user module, a request generator, for automatically compiling a request for a quote, said request comprising the deadline and any link to the IP office correspondence having a reply deadline; said communication means further configured to: automatically provide agent modules with said request for a quote, said agent modules corresponding to the list of one or more agents in said jurisdiction, receive a resulting quote from the agent module(s), automatically provide said quote(s) to said user module, receive an agent selection from the user module, and in response to said agent selection, automatically provide the selected agent with instructions to respond to the IP office deadline.

In one aspect, the database clustering engine further automatically generates a master unique identifier to associate the serial number of the IP document with the serial number of a related second IP document of another jurisdiction, for grouping members of an IP family. In this way, information displayed on the display of a user module may optionally be grouped by IP families.

In one aspect, the communication is further configured to receive, from said user module, information corresponding to additional agents in said jurisdiction. This option allows the user to obtain quotes from agents of his/her own choice.

In one aspect, the present invention further comprises: a garbage collector for deleting said deadlines, said links to said IP office correspondence having a reply deadline, and said associations between the IP office correspondence having a reply deadline and both the serial number and jurisdiction, when a current date is past the calculated deadline, in order to conserve storage space on the mass storage device.

In one aspect, the present invention further comprises a text crawler, configured to automatically: extract relevant headings and/or relevant legal provisions from said IP office correspondence having a reply deadline, and generate a summary of said IP office correspondence having a reply deadline, said summary configured to be displayed on said display of said user module.

In one aspect, the input is a serial number selection.

In one aspect, said database clustering engine automatically generates an owner and/or applicant identifier for associating the IP document with the corresponding owner and/or applicant, wherein the search engine is configured to receive an owner and/or applicant name input from a user module, and wherein in response to receipt of said owner and/or applicant name input, the service module automatically displays on the user module, a list of IP documents having said owner and/or applicant, the IP-related information, the link to IP office correspondence having a reply deadline, and said corresponding deadline(s), retrieved by the search engine.

In one aspect, said IP-related information further includes one or more selected from the group consisting of: owner, applicant, trademark, title, IP document, agent, correspondent, filing date, priority date, class, service and wares, postal addresses, IP document record, and links thereto.

In one aspect, the present invention provides A method for automatically transmitting instructions to an agent module to respond to an IP office deadline selected by a user module, said method comprising: automatically identifying and extracting IP-related information from an IP office computer system for multiple IP documents, wherein said IP-related information includes jurisdiction, serial number, and deadline-generating dates; automatically generating links to electronically accessible IP office correspondence having a reply deadline; processing and clustering the extracted IP-related information, by automatically generating a sub-unique identifier to associate an electronically accessible IP office correspondence having a reply deadline with the serial number of a corresponding IP document, and automatically generating an IP jurisdiction identifier to associate the IP office correspondence having a reply deadline with the jurisdiction of the corresponding IP document; storing said IP-related information; said deadlines; and said links to IP office correspondence having a reply deadline on a storage device, each IP office correspondence having a reply deadline being associated with (i) the sub-unique identifier, and (ii) the IP jurisdiction identifier; agent records, each agent record including (iii) an agent jurisdiction identifier to identify the agent's jurisdiction; automatically executing a set of computer executable statements and instructions to calculate a deadline for each of said deadline-generating dates; automatically associating said deadline to said IP office correspondence having a reply deadline and to said corresponding sub-unique identifier; automatically determining the agent records having the agent jurisdiction identifier matching the IP jurisdiction identifier of said IP office correspondence having a reply deadline, to generate a list of one or more agents in said jurisdiction; in response to an input from the user module, automatically retrieving the IP-related information, the link to IP office correspondence having a reply deadline, and said corresponding deadline(s), associated with one or more corresponding sub-unique identifiers, and automatically retrieving the generated list of one or more agents in said jurisdiction corresponding to said agent jurisdiction identifiers; in response to said input from the user module, automatically displaying on a display of the user module, the IP-related information, the link to IP office correspondence having a reply deadline, and said corresponding deadline(s), in response to said input from the user module, automatically displaying on the display of a user module, the generated list of one or more agents in said jurisdiction, receiving a selection of an IP office correspondence having a reply deadline from the user module, automatically compiling a request for a quote, said request comprising the deadline and the link to the IP office correspondence having a reply deadline; automatically transmitting to agent modules with said request for a quote, said agent modules corresponding to the list of one or more agents in said jurisdiction; receiving a resulting quote from the agent module(s), and automatically provide said quote(s) to said user module, receiving an agent selection from the user module, and in response to said agent selection, automatically providing the selected agent with instructions to respond to said deadline.

The method of may further comprise automatically generating a master unique identifier to associate the serial number of the IP document with the serial number of a related second IP document of another jurisdiction, for grouping members of an IP family, and storing said master unique identifiers on the storage device.

The method of may further comprise receiving from said user module, information corresponding to additional agents in said jurisdiction.

The method of may further comprise deleting said deadlines, said links to said IP office correspondence having a reply deadline, and said associations between the IP office correspondence having a reply deadline and both the serial number and jurisdiction from the storage device, when a current date is past the calculated deadline, in order to conserve storage space.

The method of may further comprise: extracting relevant headings and/or relevant legal provisions from said IP office correspondence having a reply deadline, and generating a summary of said IP office correspondence having a reply deadline, said summary configured to be displayed on said display of said user module.

The method of may further comprise automatically generating an owner and/or applicant identifier for associating the IP document with the corresponding owner and/or applicant, receiving an owner and/or applicant name input from a user module, and wherein in response to receipt of said owner and/or applicant name input, automatically displaying on the user module, a list of IP documents having said owner and/or applicant, the IP-related information, the link to IP office correspondence having a reply deadline, and said corresponding deadline(s), retrieved by the search engine.

### DESCRIPTION OF DRAWINGS

FIG. 1 is a flow chart of a trademark prosecution process

FIG. 2 is a flow chart illustrating a method of using the deadline response management system, according to an embodiment of the present invention.

FIG. 3A-3C shows a technical flow of the data acquisition and processing engine of the system in accordance with one embodiment of the invention.

FIG. 4 is a flow chart showing an overall operation of a system in accordance with one embodiment of the invention.

FIG. 5A-5C show operation details of the system in accordance with one embodiment of the invention.

FIG. 6-13 show examples of user interface screens presented by the system to the user, in accordance with one embodiment of the invention.

FIG. 14 shows an example of a user interface screen for selecting a new serial number and order, in accordance with one embodiment of the invention.

FIG. 15A shows an example of an automated email sent to an agent, in accordance with one embodiment of the invention.

FIG. 15B shows an example of the display on the agent's computer after clicking a link in the email of FIG. 15A, in accordance with one embodiment of the invention.

FIG. 16 shows an example of the agent's computer display, if the agent selects the decline option.

FIG. 17 shows an example of the agent's computer screen for agent input.

FIG. 18A-18B shows screen displays on the agent's computer after entry of quotes.

FIG. 19 shows an example of a screen display on user's computer.

FIG. 20 shows an example of a screen display on user's computer displaying one or more quotes.

FIG. 21 shows an example of an office action document.

FIG. 22 is an example of a screen display of a status dashboard.

FIG. 23 is a screen display showing trademark details.

FIG. 24 is a screen display showing an outline of billing information and quote.

FIG. 25 is a screen display for selecting currency.

FIG. 26-28 is a series of screen displays where payment details are entered and confirmed

FIG. 29 is a display screen confirming order completion.

FIG. 30 is a main interface display screen.

FIG. 31 is a display screen showing a summary.

FIG. 32 is a screen display of a sample invoice.

FIG. 33 is a screen display of a user profile.

FIG. 34 is a screen display allowing user to add email addresses.

FIG. 35 is a screen display allowing user to change account password.

FIG. 36 is a network diagram showing machines in a system in accordance with one embodiment of the invention.

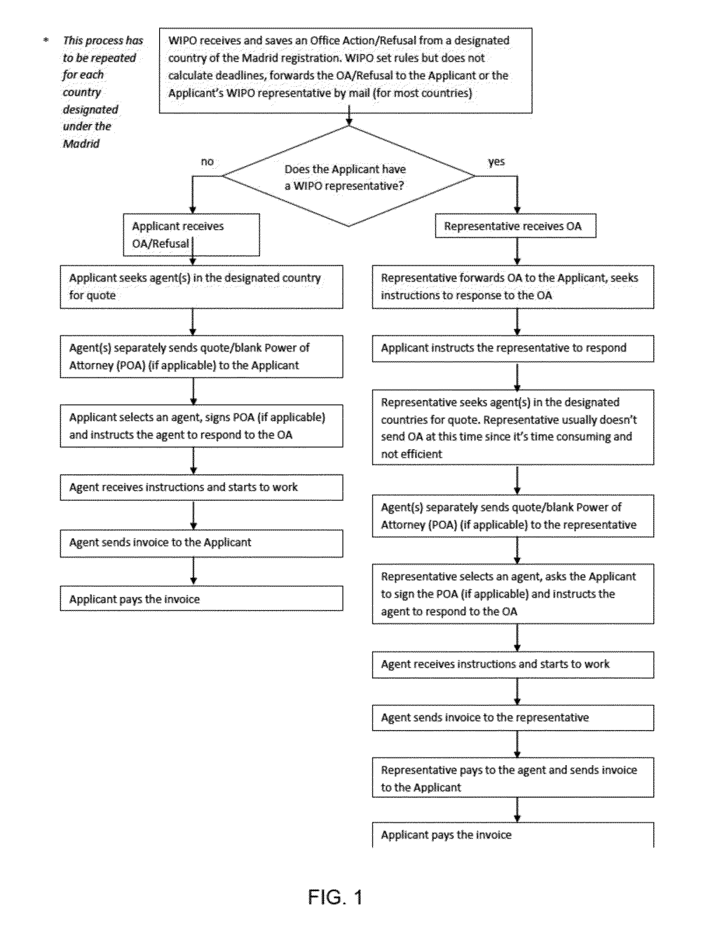

### DETAILED DESCRIPTION

The presently disclosed embodiments are directed to a computer implemented system for accessing, assembling, centralizing IP application information and providing cost quote information relating to generation of work-products for identified IP documents.

As used herein, the term ‘intellectual property’ relates to the various forms of IP, including patents, trademarks, industrial designs, copyrights, trade dress, plant breeders' rights, in particular trademarks and patents.

As used herein, the term ‘IP-related deadline’ or ‘intellectual property-related deadline’ refers to a deadline for making a fee payment and/or submission to an IP office. Such deadlines include replies to Office Actions, replies to refusals, revival deadlines, reinstatement deadlines, opposition deadlines, deadlines to file documents, and deadlines to pay fees (e.g. grant fee, allowance fee, maintenance fee, late fee, reinstatement fee).

As used herein, the term ‘IP Office’ refers to a governmental or intergovernmental organization that controls the issue of intellectual property, such as patents and trademarks. Examples of IP Offices include the Canadian Intellection Property Office (CIPO), the USPTO, OHIM, and UKPTO.

As used herein, the term ‘IP document’ refers to any IP application or IP grant. Examples include trademark applications, granted trademarks, patent applications, and granted/issued patents.

As used herein, the term ‘IP-related correspondence having a reply deadline’ refers to any letter or document generated by an IP Office setting out a deadline for responding thereto. Examples of IP-related correspondence having a reply deadline′ include Examiner's Refusal/Report, Office Actions, Statement of Opposition, Notice of Allowance, Notice of Abandonment, Notice of Default, Counterstatements, Order to Cross-Examine, Notice to File Written Arguments, and Notice of Attendance at Oral Hearing.

As used herein, the term ‘deadline-generating date’ refers to any dates associated with the IP document that result in a deadline for responding. The term includes, for example, filing date, grant date, and dates of IP-related correspondence having a reply deadline. Some deadlines are generated based on the date such correspondence is dated; some deadlines may be based on filing or grant dates, such as maintenance fees.

As used herein, the term ‘agent’ refers to a person authorized to act before one or more IP Offices in respect of IP matters. The term also includes Firms or other entities that have agents and/or which are authorized to act before the respective offices.

Throughout much of the description reference is made to trademarks and to refusals. However, it should be understood that the present application is also applicable to other forms of IP, such as patents. Also, it will be understood that the present application is applicable to other types of deadlines, not just reply deadlines to Refusals. Examples of deadlines are discussed above with respect to IP-related deadlines.

The computer and machine generated systems are configured to process, exchange and receive information or records for industrial property (IP) types such as a patent, trademark or industrial design (“collectively Industrial Property Type(s) or “IPT”) between different jurisdictions/countries, identify and attribute common identifiers such as number of application or registration, applicant or owner name, country code or IP office country code and type of IP. Thereafter, the machine generated system, communicates with a computing device to compile and store the IPT data in clusters in a computing device relating to the IPT record. For instance, for each country, the computing devices execute a set of computer executable instructions to extract active records based on status of each record and event of the IPT in each country of the corresponding IPT. Once the computing device has identified the relevant IPT by a unique identifier such as a serial number, another set of computer executable instructions locates and identifies an office action/refusal within the records of an IPT. The computing device then executes a further set of computer executable instructions to extract active office action/refusal in each country of an Industrial Property Type. Thereafter, the computing device compiles and clusters the output or Industrial Property Type Office Action Data and assigns it via a processor, a Sub Unique Identifier. This Sub Unique Identifier can be a virtual serial number or tag that is associated to a specific IPT and linkable to several different IPTs in different jurisdictions that have the same owner type characteristics so that the system can cluster them, and defines a means to identify them with, by example, one serial number. Thereafter the computing device joins or links the Industrial Property Type Office Action Data in each country or jurisdictions where Industrial Property Type Office Action Data exists and having a Sub-Unique Identifier to a common identifier such as owner name or agent exists and assigns it a Master Unique Identifier. This Master Unique Identifier is another virtual serial number generated by the system.

Concurrently, the computing device, for every country executes another set of computer executable instructions for each Industrial Property Type Office Action Data to compute deadlines and displays them. Thereafter the computing device executes another set of computer executable instructions for locating and delivering an office action/refusal document by country and applies the country specific formula and creates a uniform resource locator address to the document accessible to a user and displayed by country. Concurrently to the display of the uniform resource locator, the computing device executes a further a set of computer executable instructions to identify and determine one or more choices of agents for each specific country based on the jurisdiction of the Industrial Property Type Office Action Data from which a user can select or add additional agents. These determined agents can then be displayed on a display terminal. Thereafter, a user communicating with the computer system, the computer communicating with the user, sends and receives costs associated with the same.

The presently disclosed computer implemented systems provides the following advantages, which reduces the amount of time and steps in the above mentioned prior process for locating, viewing and reviewing office action/refusal documents. Second it is reduces the time required to determine the deadline associated with a specific office actions/refusals in a single or multiple jurisdictions. Third, it further reduces the time and steps required to obtain specific pricing from multiple agents and instruct those agents. Users can find and locate with one single serial number, all relevant refusals/office actions issued in multiple jurisdictions on the system. The system automatically creates and updates all ongoing Industrial Property Type Office Action Data its corresponding deadlines all associated with a company/client/agent in a jurisdiction and any corresponding foreign jurisdiction that have received office actions/refusals that is pending. The computer system delivers or provides access to a client/user system accessible by a user/professional representative all applicable Madrid Protocol and national filing jurisdictions (USPTO, CTM, CIPO) office actions/refusals documents in a PDF format centrally. The system can prepopulate POA required by country for a receiving agent to respond to Office actions/refusals. The system automatically calculates deadlines and delivers to and displays in a client system, deadlines for each office action/refusal by jurisdiction. The system displays by jurisdiction together with office action/refusal, and a listing of foreign agent or agents that provide a fixed fee quote to respond to specific office action/refusal in specific jurisdiction. The system is flexible enough to enable the addition of agent(s) to whom office action/refusal should be delivered.

The system allows requests for a quote with one single serial number from added agent to whom office action/refusal document has been delivered. The receiving local agent can review specific office action/refusal from their client system and provide quotes to multiple clients or potential clients from their client systems. With the host system and the client systems, the systems helps receiving agents increase and deliver number of paying clients to receiving agents. The computer system saves time in client acquisition such that the potential client engagement and interaction of back and forth for client to retain an agent is facilitated and reduced with the delivery of a client or potential client that has specific issue, a specific deadline and needs a resolution. The system facilitates communication for instructing agents to find, send documents and contact potential receiving agents for quotes. Receiving agents can review office action/refusal documents and provide pricing in a time efficient manner. The system facilitates the instructing agent to receive multiple quotes from multiple receiving agents from either the same or multiple jurisdictions. Similarly, the instructing agent can easily choose between competing agents in same jurisdiction. The system enables instructing agent to instruct multiple agents to respond to specific office action/refusals for multiple countries from one single user interface.

Other conveniences are made available by the system. The system allows the instructing agent to pay in one single currency multiple agents responding to specific office action/refusals in different countries with one sum payment and once single currency. The system ensures receiving agents receive guaranteed payment within a guaranteed period. The system can also collects statistics on types of office actions/refusals issued by jurisdiction, and the cost to respond to the office actions/refusals.

At the present time, users have access to information from various and disparate sources. For the purposes of monitoring, WIPO has a Madrid Electronic Alert (MEA) tool which allows users who hold a free account, to create a list of international registration numbers of particular interest, and receive an e-mail each time an inscription concerning one of them is recorded in the International Register. This requires users to manually create their own list of international trademark registrations. The received messages provide a hyperlink based on serial number to a basic information page of the specific international registration number (IRN) on the ROMARIN, the International Trademark Register database. At this database, the user can find further details on the changes by the IRN by viewing different tabs, based on Full details, Summary by office or by documents.

Another monitoring tool is the Madrid Real Status (MRS), which provides the history of a trade mark. It is a service that the user can access by going to the WIPO site or access from the user's account on the MEA. The MRS information such as the document ID, provides a link by serial to the type of action (service type), a document ID, the notification date, the country of origin. But no link to the specific document is provided. The email notification from the MEA contains the IRN, the mark name, the type of service and a link to the subject Madrid Electronic Alert.

Some document delivery tools are available. The Madrid Portfolio Manager (MPM) is an online service that allows holders of international registrations and their representatives to access their international trademark portfolios. In the MPM, a user must use a search feature to collect all the relevant marks for its international portfolio and link them by the same email address. The user can view with a document ID a link to display any PDF document such as a notification office action or refusal. The MPM has the following tabs: Portfolio, E-Renewal, E-Payment, Delegation, Applications, Notifications, Upload, Contact and Log Out. Under the Application tab, users can view office actions/refusals for a pending international application. A pending international application will show office actions whereas once the mark is registered and one designates countries, one must move to another tab to view designations from an international registration. Under the Notifications tab, users can view notifications or office actions/refusals sent by WIPO with a document ID and a link displaying the notification document sent by WIPO to the WIPO Rep. The tabs display the date of notification and type of notification and international office issuing the notification of office action or refusal. However, no deadline is provided on the interface, but the deadline is set out in the PDF document issued by the international office.

The Trade mark eAlerts from the UK IPO offers a service that will alert users to the progress of a United Kingdom (UK) trade mark or an International Registration (IR) with the creation of an account when: international Registration is published or opposed; International Registration is protected in the UK; the status of the mark is changed to DEAD; an International Registration has been renewed; Restriction or limitation to the International Registration has occurred; an application to declare the International Registration invalid or to revoke has been submitted; Appointment of a new representative before IPO has been acknowledged. For this tool, the user has to the go the main webpage relating to the specific serial number and then proceeds to a document tab and locate the relevant Office Action by date.

The CTM/RCD alerts is a similar service to Trade mark eAlerts, and is offered by European Community trademarks office (Office of Harmonization for the Internal Market). The web page can be currently accessed at https://oami.europa.eu/ohimportal/en/news/-/action/view/926665

The USPTO delivers office actions/refusal documents via PDF link to users or professional representative via email for national applications only.

There are other services or tools such as from Weekly 66a First Office Actions (refused extensions of protection under Madrid) from Towergate Software (www.towergatesoftweare) that sells customers Designated Member's National Office Action information (extension of protection of) international registrations filed under section 66(a) in the United States that have recently received a first office action (refused). It is noted that the list is filtered to show only the applications of foreign owners without domestic representation (http://towergatesoftware.com/blog/2011/12/10/weekly-66a-first-office-actions/). The report lists the following details; the foreign correspondent, owner and trademark registration with a link to the USPTO page setting out the trademark details.

According to a present embodiment, a trademark office action management system is provided which includes a host computing system, at least one owner computing system and at least one agent computing system. The host computing system is configured to access and assemble information relating to all new, existing and updated trademark applications and registrations at any predetermined frequency, such as daily, from various existing on-line databases and publicly accessible on-line sources. The trademark office action management system includes mass storage, or cloud based storage for storing the extracted data.

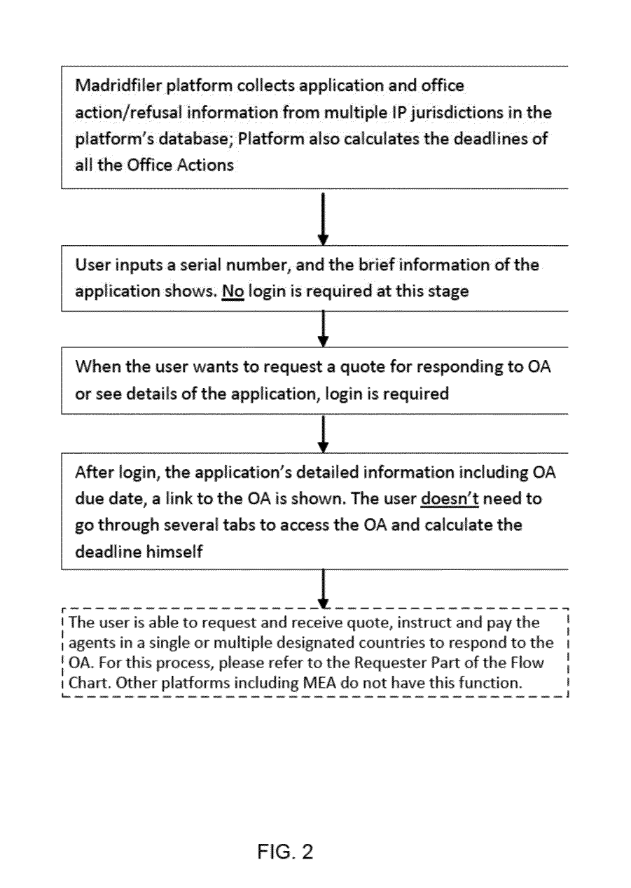

Prior to a specific description of the trademark office action management system, an overview of how the system operates is first described. FIG. 2 is a flow chart illustrating the method of using the trademark office action management system, according to an embodiment of the present invention. In the present example embodiments, the trademark office action system is also referred to as the Madridfiler platform. During specific periods of time, the system collects application and office action/refusal information from multiple IP jurisdictions in the platform's database. The processor of the system is configured to mathematically calculate the deadlines of all the Office Actions/Refusals. The collected information is used to populate the local system database having fields corresponding to those from the other sources. Then a user, such as a trademark owner or agent, accesses the system through their own computer terminal or mobile computing device such as a smartphone or tablet by example. The user inputs a serial number, and the brief information of the application is presented on their display. No login by the user is required at this stage, according to the present embodiment.

When the user requests a quote for responding to an OA, or wishes to see details of the application based on the displayed brief information, login is required. After login, the application's detailed information including the calculated OA due date, and a link to the OA is generated and displayed. Concurrently if there are several jurisdictions or one jurisdiction where there is an OA, the system will display the list of countries but only chose one country for display. In addition to displaying the OA due date for the country displayed, the system will display on the client system automatically the agent or agents available to provide a quote to respond to the OA. Accordingly, the user does not need to go through several tabs from different sources and databases to access the OA and calculate the deadline. Via a user interface, quotations can be requested by the system by issuing requests to the agent systems, which are displayed on the client system automatically when the user selects a country of the OA. The user can then view and select agents from the user interface to respond to the OA. In short, the system allows a user to request and receive a quote, instruct and pay agents in a single or multiple designated countries to respond to the OA. Further details of this process executed by the system are shown later.

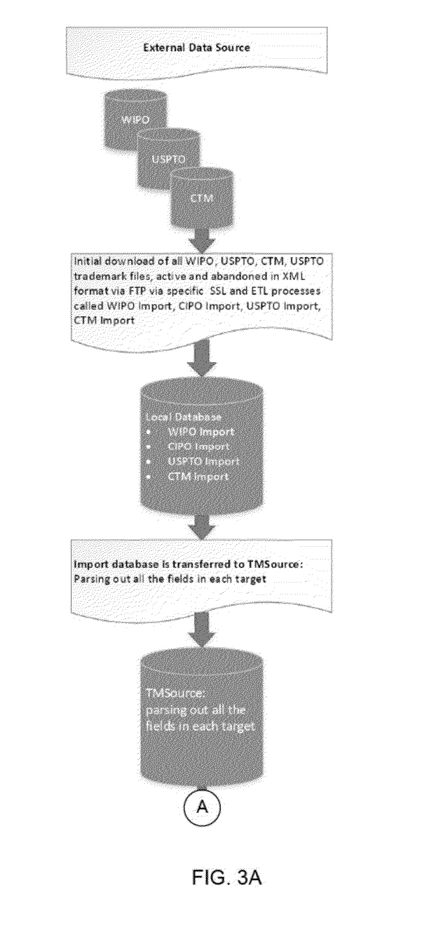

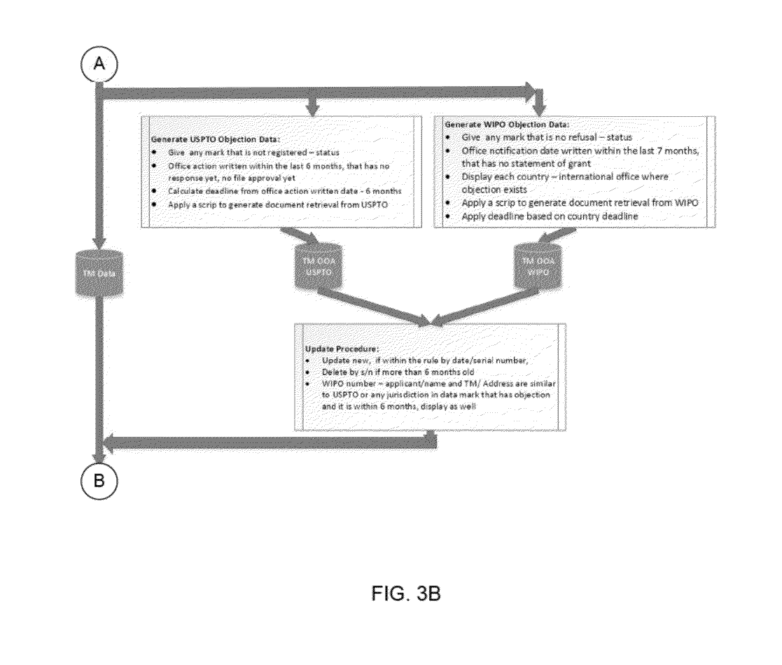

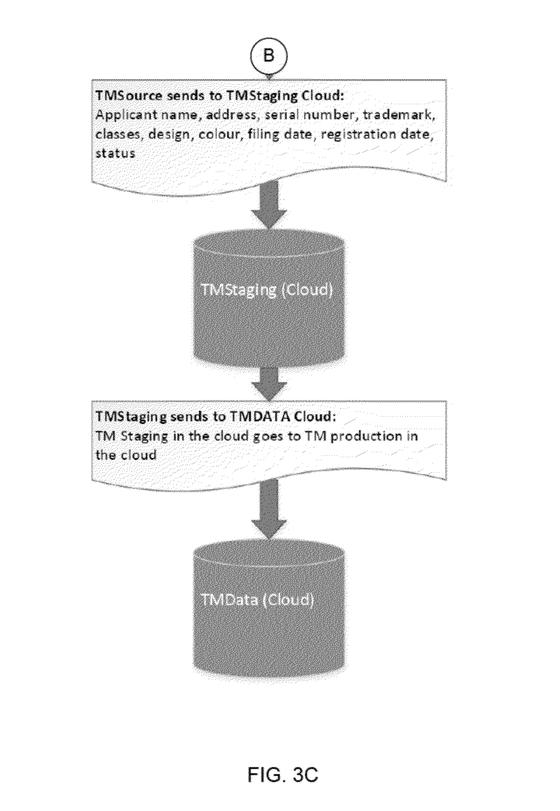

FIGS. 3A-3C shows a technical flow of the data acquisition and processing engine of the trademark office action management system. The data acquisition and processing engine is executed by the processors of the host computing system in the present embodiment. In this particular embodiment, several servers and databases can be used to host and implement the data acquisition and processing engine. There is included a TM Import Server Local, which includes SSIS packages and ETL tools to load data into the local server in several different databases divided by jurisdiction. There is includes Server Synchronization tools between TM Import Server Local and TMSource Local Server. The TMSource Server Local executes a set of computer executable instructions that parses the data into distinct and separate fields and applies the formula, reduces the number relevant fields, prepares and transforms data ready for cloud transfer, acts as computing device and interconnection between the local servers and the cloud servers. The Data storage server stores all the collected data. The TMSource Dev Local is a redundant server that mimics the production environment.

There are synchronization tools between information stored in the cloud and locally. These tools Load data into TMdata Staging, which (staging is an intermediary server environment used assemble, test and review its data and changes before it is moved into production), they add and delete current data in TMdata Staging, and Receive and send orders from TMdata Cloud (this is the server data and environment that is located in hosted environment outside the local servers on the internet) to TMdata Local (local server and data environment that is not accessible to the public behind security and firewalls located in a different physical and spatial locations).

The Cloud servers are hosted with MS Azure, and include TMdata staging, execute synchronization between TMdata staging and TMdata, and TMdata (production).

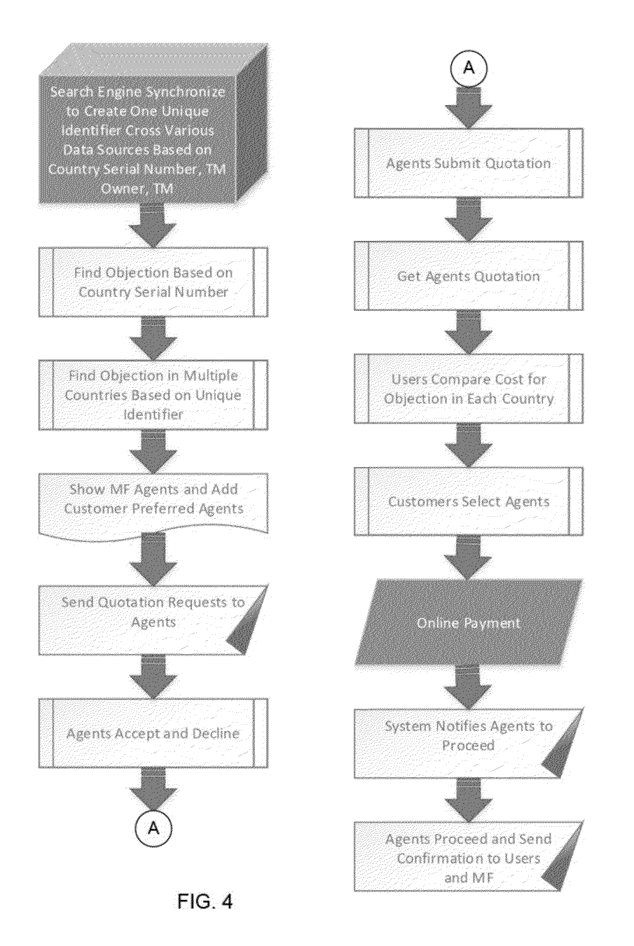

The overall operation of the system is shown in the flow chart of FIG. 4. The search engine synchronizes to create one unique identifier across various data sources based on the country serial number, TM owner and TM, by example. Then the Office Actions/Refusals based on the country serial number are searched and identified. Office Actions/Refusals in multiple countries based on a unique identifier are found. Then MF agents are displayed, and the option to add preferred agents is provided. Quotation requests are then automatically issued to selected agents by the system, via email by example. The receiving agents then have the option to accept or decline the request to provide a quotation. This is typically done at the agent system, which can be a computer workstation or mobile computing device. Once the agent submits a quotation, the quotations are received by the system and logged. Then the system sends a notification to the user. The user then clicks a unique uniform resource locator address without requiring login to review the details of the quotations received from the agents. Upon clicking this link the quotes are displayed. The user can later log in via a dashboard and view the same information. The owner or user can then select agents based on the displayed quotation information. The system provides an integrated payments system, by which the owner makes payment through credit card or any other similar on-line payment method or wire transfer. Once payment has been validated, the system automatically notifies the selected agents with authorization to proceed with work.

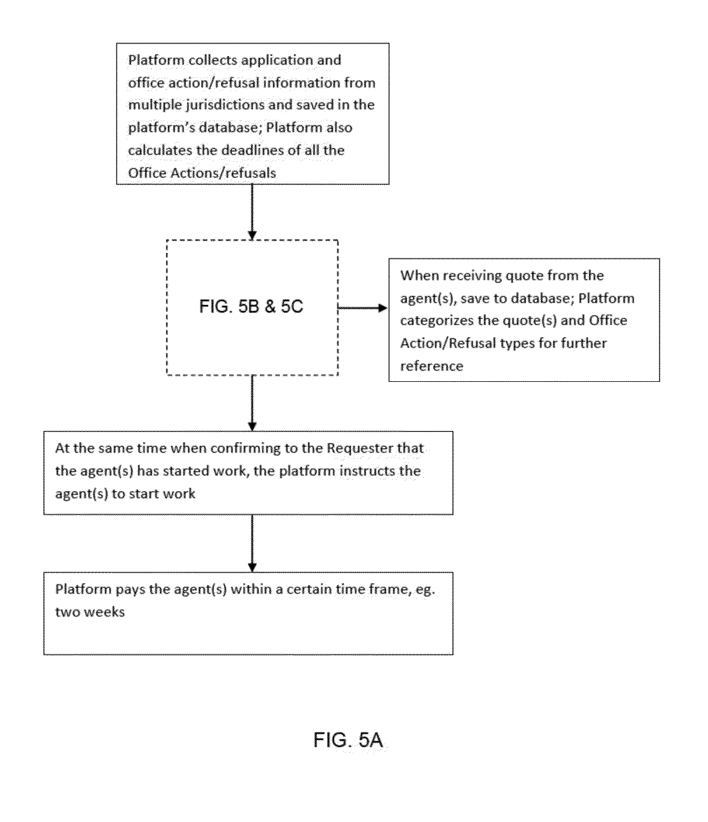

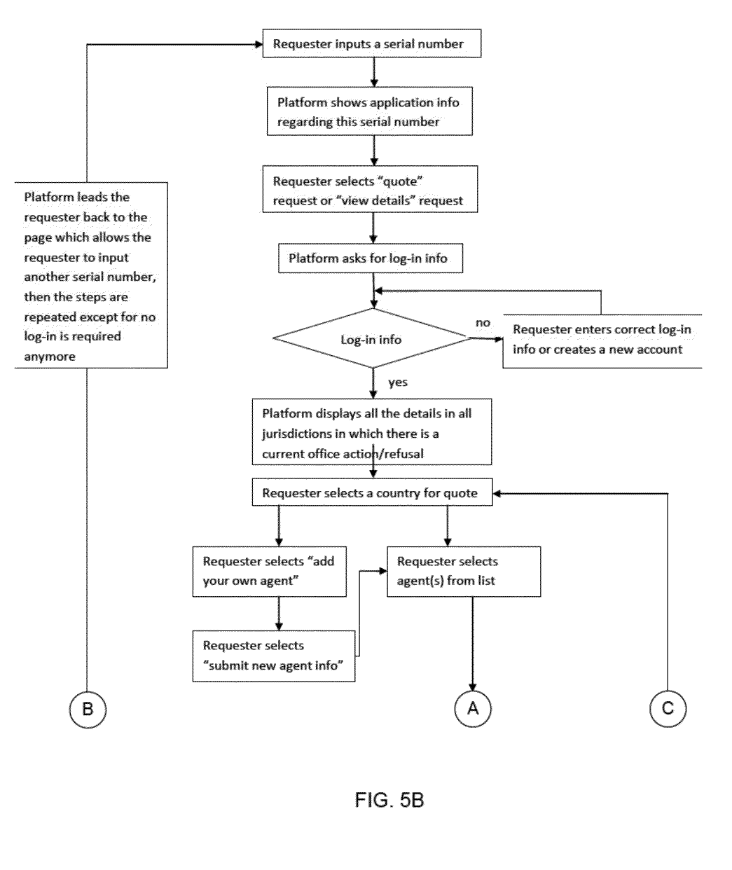

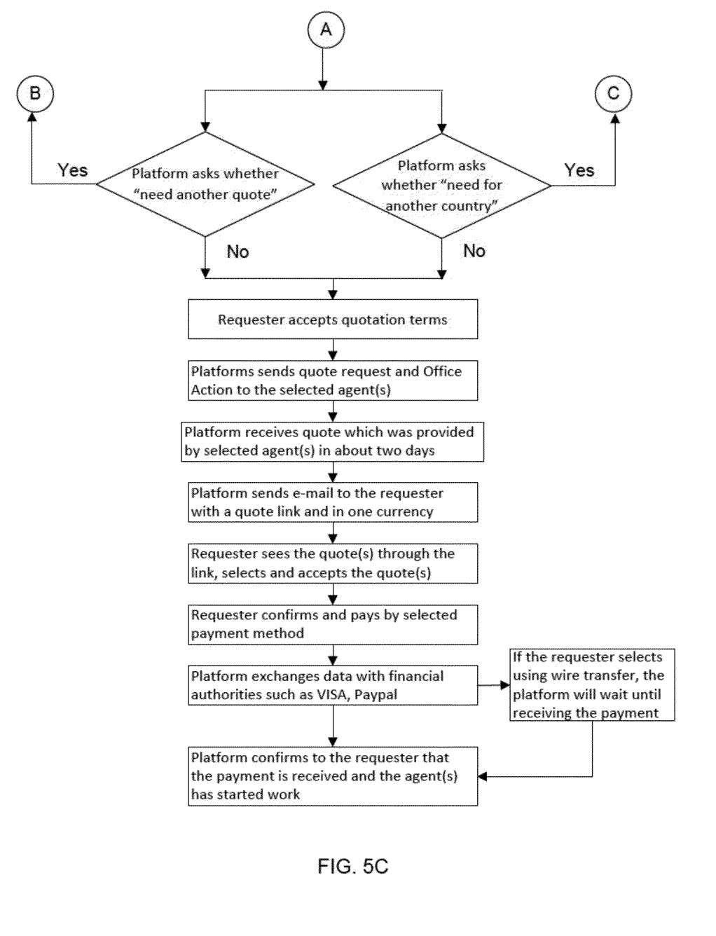

Details of the operation of the system in conjunction with the user/owner and agents is now described with reference to FIGS. 5A, 5B and 5C. Starting with FIG. 5A, the system collects application and office action/refusal information from multiple jurisdictions and saves it to platform's local database. During this process, the deadlines of all the Office Actions/refusals is calculated and stored with the corresponding records. At some predetermined time, certain information is deleted, such as applications where the Office Action/Refusals deadlines have passed, in order to conserve data storage space. By example, data from the CIPO data base is added and deleted on a weekly basis. Then the user, or requester, enters a serial number. This portion of the operation is shown in the requester flow chart of FIGS. 5B and 5C, and is discussed later. For the time being, it is assumed that requests for quotations have been made. Returning to FIG. 5A, received quotes from the agent(s) are saved to the database. The system then categorizes the quote(s) and Office Action/Refusal types for further reference. Assuming that the requestor has selected agents to do the work, the system automatically instructs the agent(s) to start work, and concurrently confirms to the Requester that the agent(s) have started work. Finally, the system automatically pays the agent(s) within a certain time frame, such as two weeks for example.

Reference is now made to FIGS. 5B and 5C, in which operations of the system with the requestor are detailed. Once the requester enters a serial number, the system shows application information regarding this serial number. Via a user interface screen, the requester makes a “quote” request or “view details” request. The system queries for log-in information, which is entered as the requester has previously set up an account. Alternately, the requester can be forwarded to a different interface for creation of a new account. Once logged in, the system displays all the details in all jurisdictions in which there is a current office action/refusal, and the requester selects a country for a quote. The requester can select from a listing of displayed agents, or alternately, the requester can add a new agent. If a new agent is to be added, the requester is prompted for the relevant information that can be stored in the system database for future listing.

After selection of an agent, the system prompts for the need of any additional cost quotations. In the case an additional quote is requested, the system prompts for a new serial number, such as by leading the requester back to the page which allows the requester to input another serial number, then the steps are repeated except for no log-in is required anymore. Alternately, the requester can request information for another country for the present serial number, at which point the countries are displayed again as in the previous steps. In both decision steps, if no further quotes or countries are needed, the method proceeds to the quotation generation steps. The requester accepts quotation terms, and the system sends quote request and Office Action/Refusal details to the agent systems of the selected agent(s). It is presumed that the email addresses for the selected agents are available and stored in the database.

Agents who received their automatically generated quote requests can elect to participate or decline, both of which are recorded by the system. Once the agent quotations are received by the system, within a predetermined deadline such as 2 days by example, the system sends an e-mail to the requester with a quote link. It should be noted the cost quotations is presented to the requester in one currency of preference, regardless of the country of the quotation. An integrated currency conversion module executed by the system accesses conversion rates from an official source, and can change the listed amounts from any one currency to another based on the user selection. From the user interface, all quotes are displayed once the requester selects the quote link from the email. Once quotations are selected, the requester confirms and pays by a selected payment method. If the requester selects payment using wire transfer, the system will wait until receiving the payment, or confirmation from a financial institution. If payment is made by credit card or Paypal, or some similar on-line payment method, the system automatically exchanges data with the corresponding financial authorities. The system will then confirm to the requester that the payment is received and the agent(s) have started work.

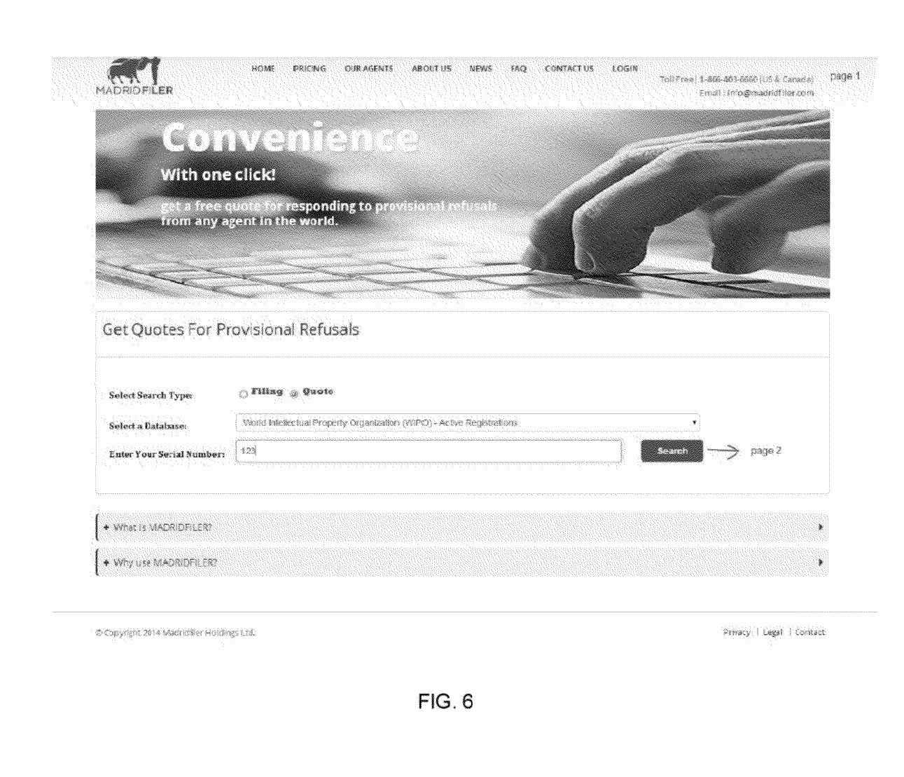

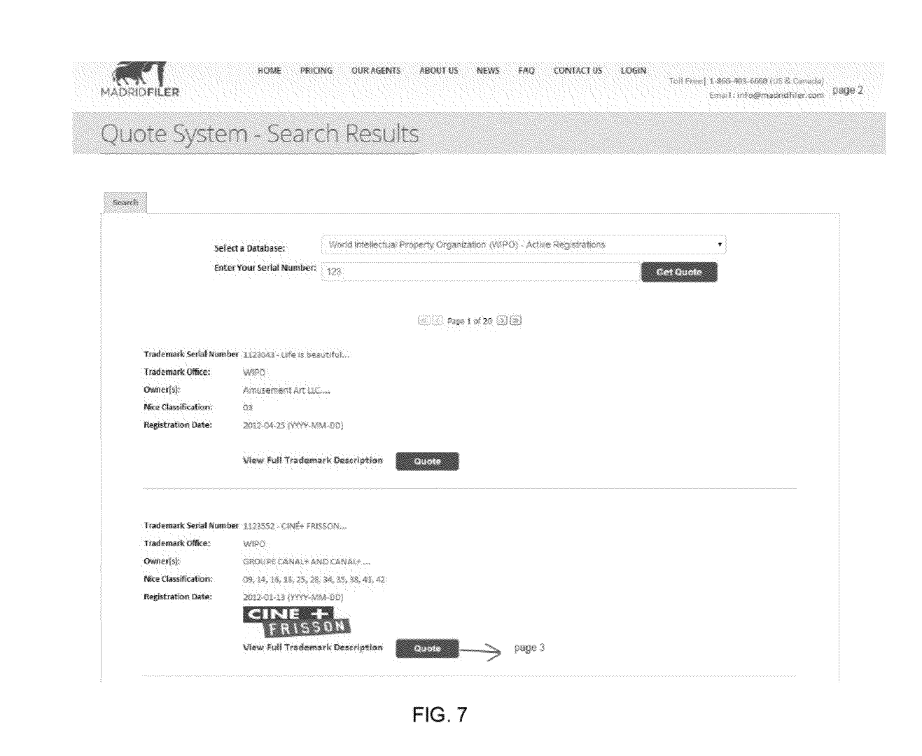

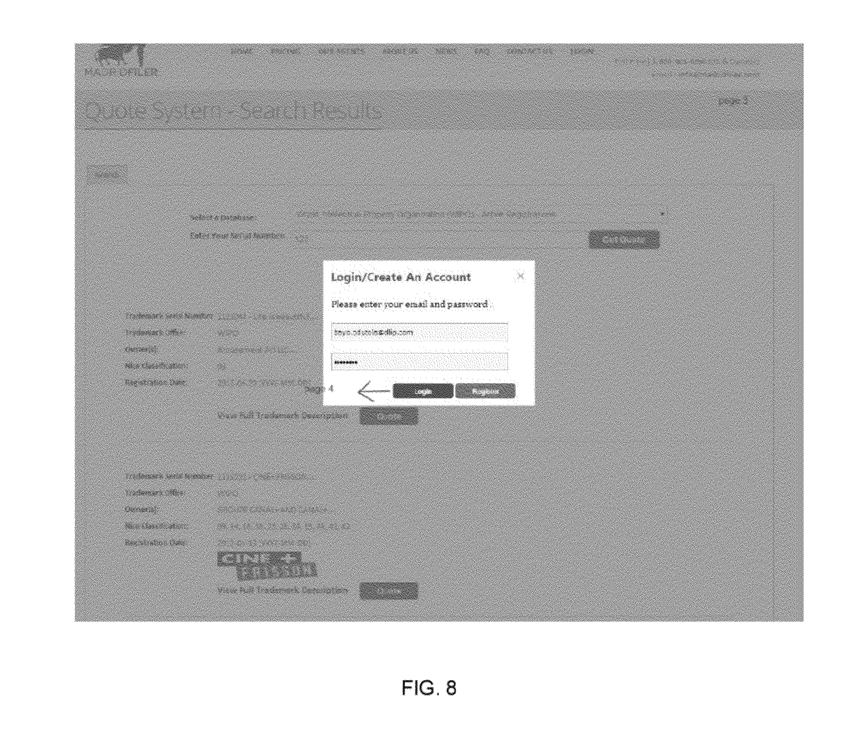

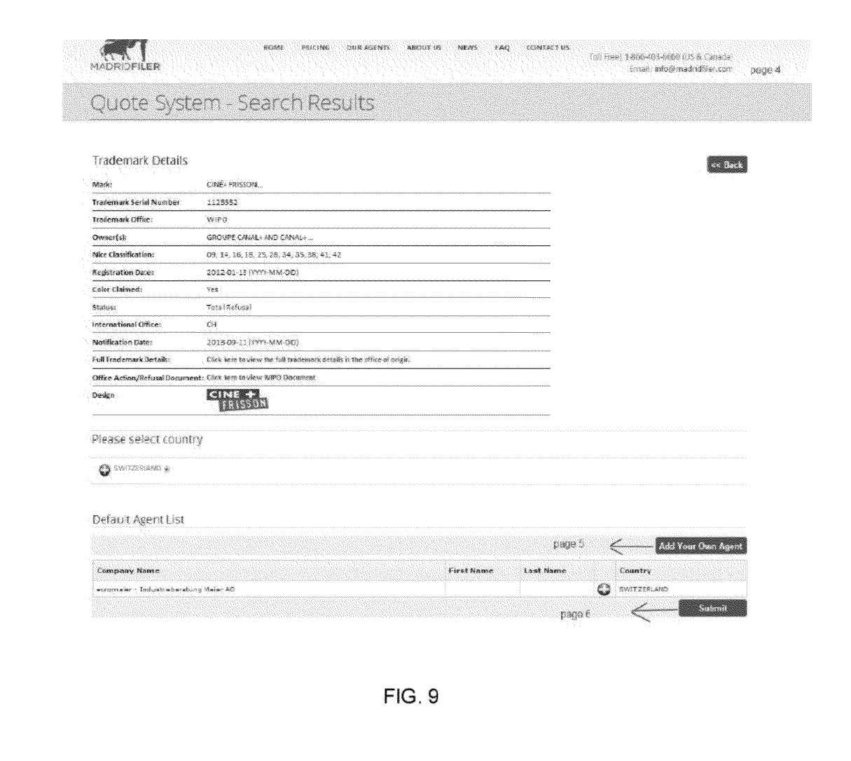

The following FIGS. 6 to 13 are example user interface screens presented by the system to the owner, at their computer workstation or mobile computing device. FIG. 6 is the first page accessible to the user upon accessing the system. Here the user selects a desired database to search, and is prompted to enter a trademark serial number to search. The identified serial number in the system database is found, and the record containing information relating to the serial number is presented on the display, as shown in FIG. 7. As previously mentioned, this is the information compiled from the different sources for the specific serial number. At this point, no login information by the user is required. However, if a quotation button on the display is selected, then a new pop up login window to prompt for account information is presented as shown in FIG. 8. Once the login information has been validated by the system, the screen of FIG. 9 is presented on the display.

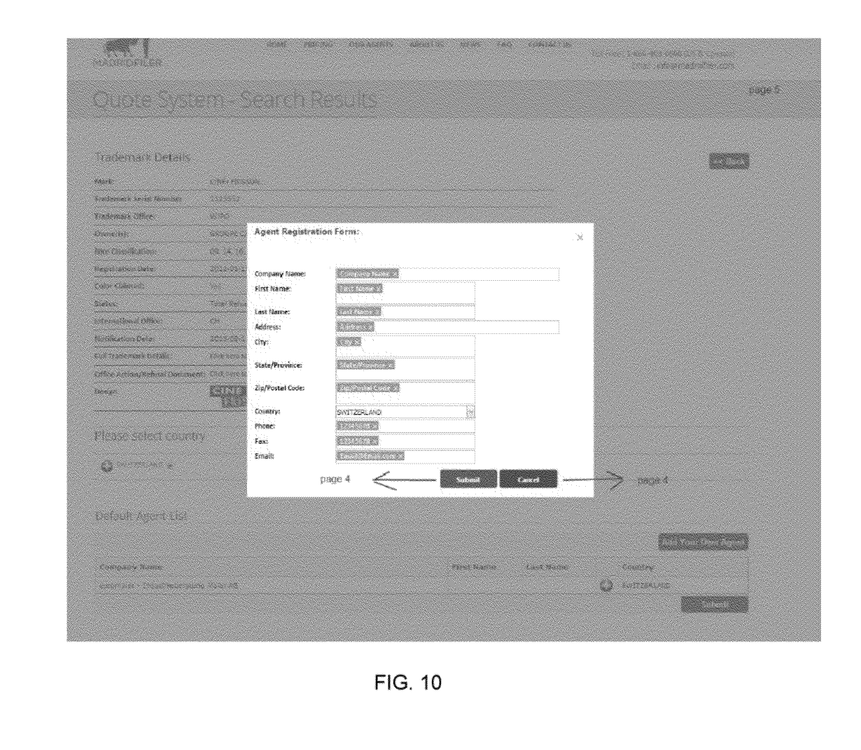

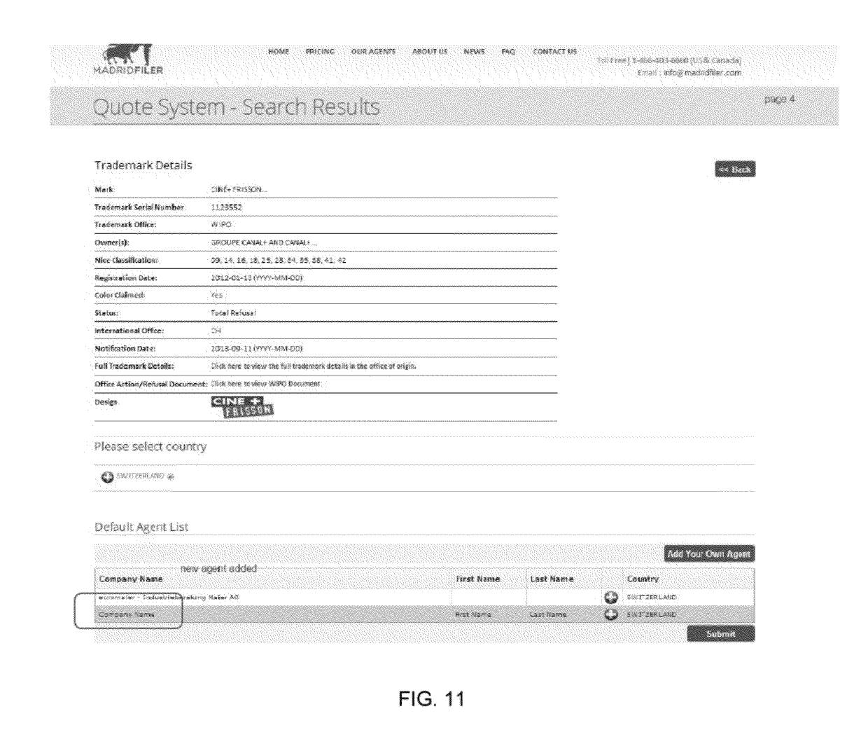

The screen of FIG. 9 provides details to allow the user to identify details associated with the trademark, such as the number of classes, the status of any office action/refusal, the date of the office action/refusal, a link to the specific WIPO or USPTO (or jurisdiction) page giving more trademark details and a link to the specific office action/refusal for from a specific IP office. Furthermore, a design is displayed if one exists for the trademark. Under the “Please select country” tab, the countries covered that currently having a specific office action/refusal is shown as a default, along with the default agent for the country. If there is no default agent for the country chosen, a message will request the user to add an agent. The screen of FIG. 10 is presented when the user selects the “Add Your Agent” button of FIG. 9. This allows the user to add details pertaining to the agent they wish to add. FIG. 11 then shows the new agent added to the list. In an alternate embodiment, all agents by country can be extracted from existing sources and stored in the system database. Then a drop down menu can be provided to allow for simplified selection of an agent.

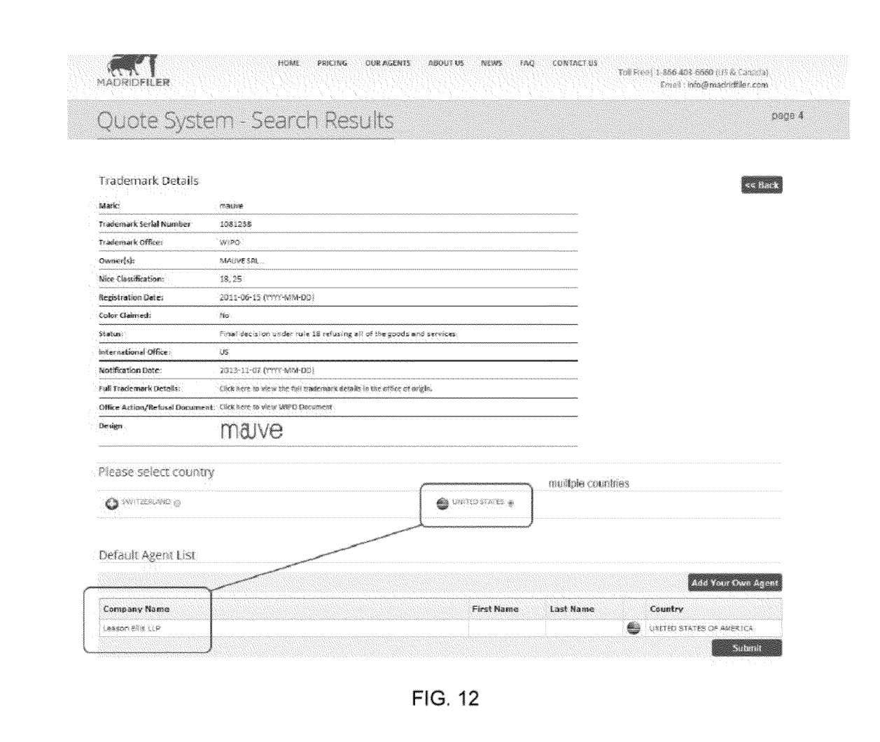

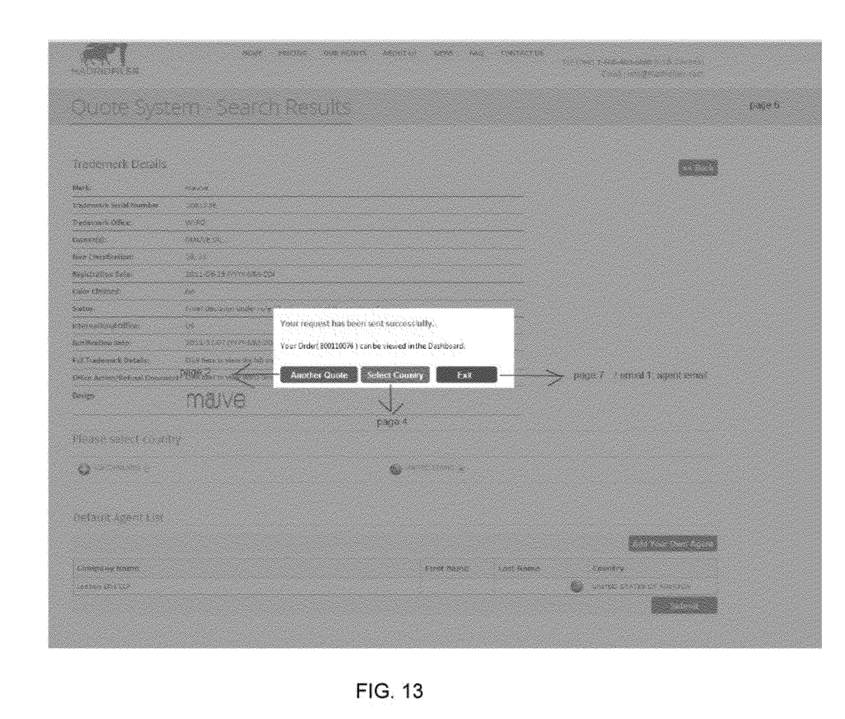

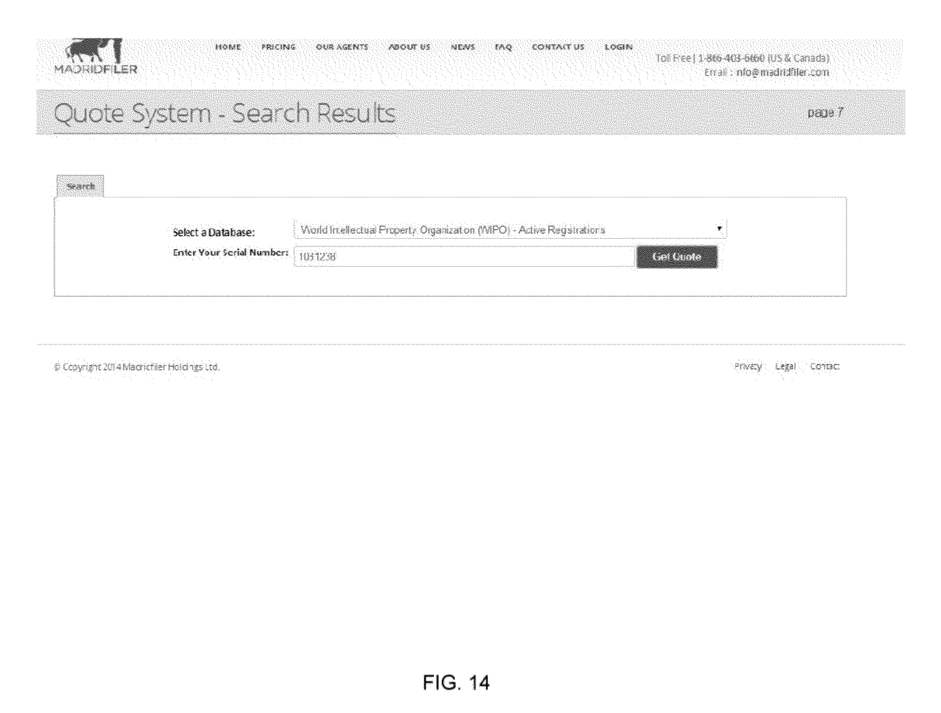

The screen of FIG. 12 is an example of a different trademark record showing office actions/refusals in two countries for the same mark, US and CH. Each time the user selects a different country, the TM details display will change to display the specific details of that particular trademark, the office actions/refusals document and as well, the default agent if one exists. From this screen, or the screens from FIGS. 9 and 11, the user can select the “Submit” button for the system to automatically send a quotation request to the selected agent(s), at which point the confirmation screen of FIG. 13 is generated. The user then has the option to exit the system, select another country or another quote. For example, if the user exits the order for that trademark serial number is completed, then they are presented with the screen of FIG. 14 for selecting a new serial number and order, if necessary.

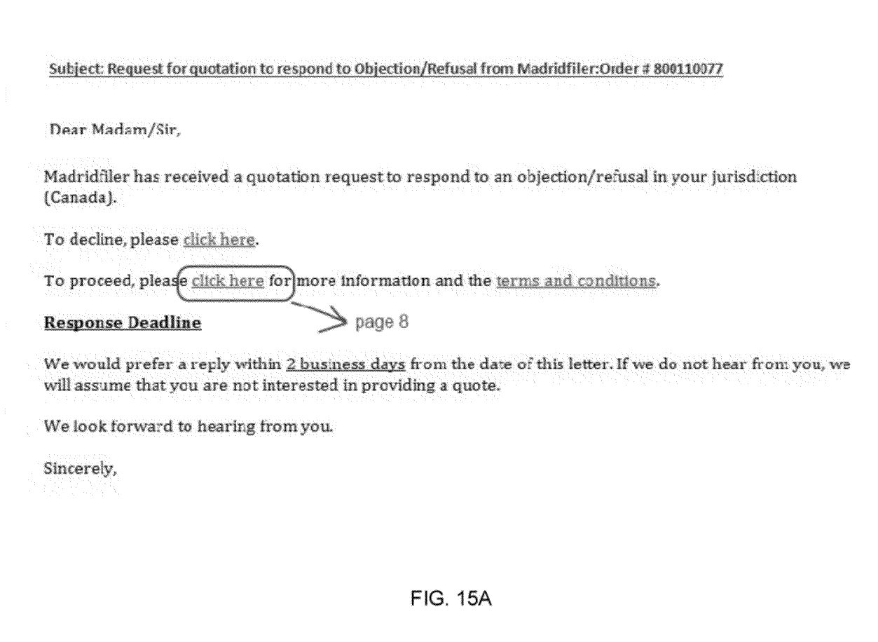

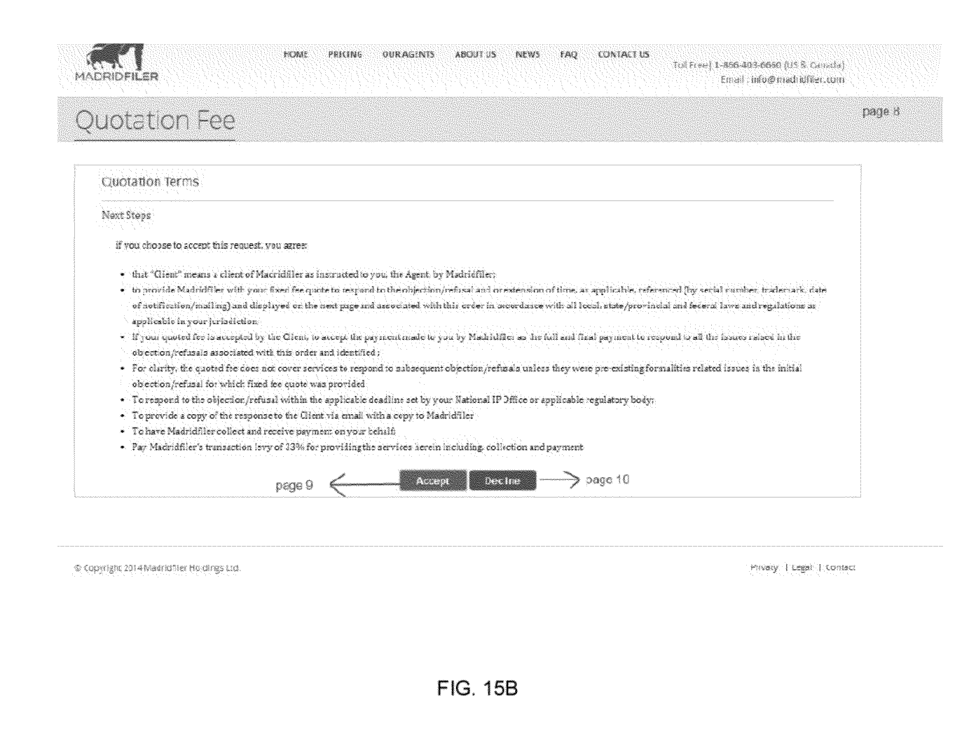

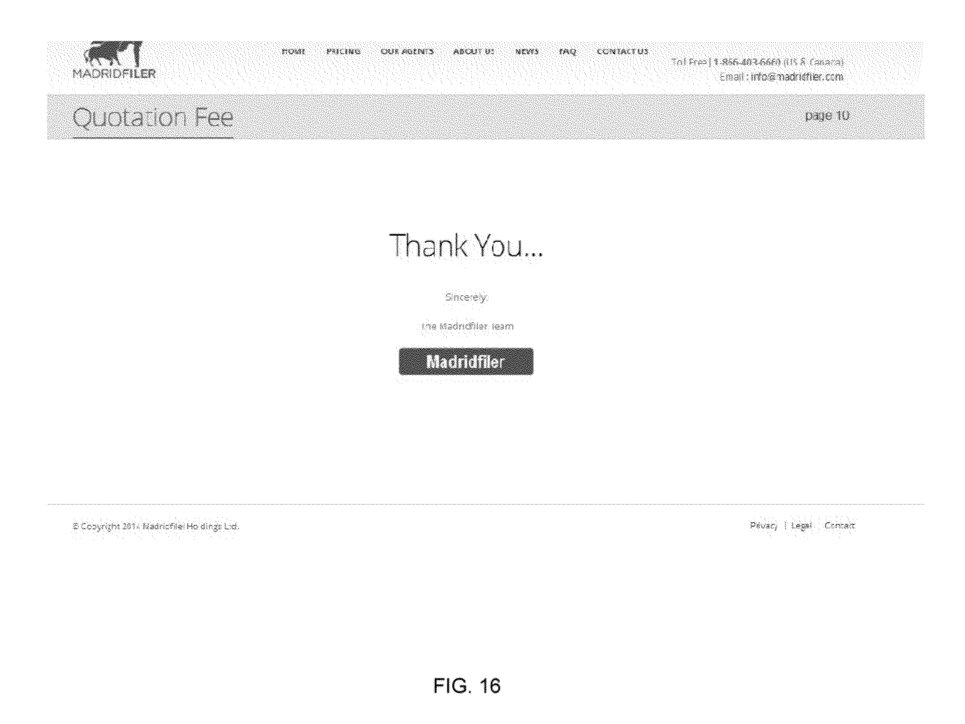

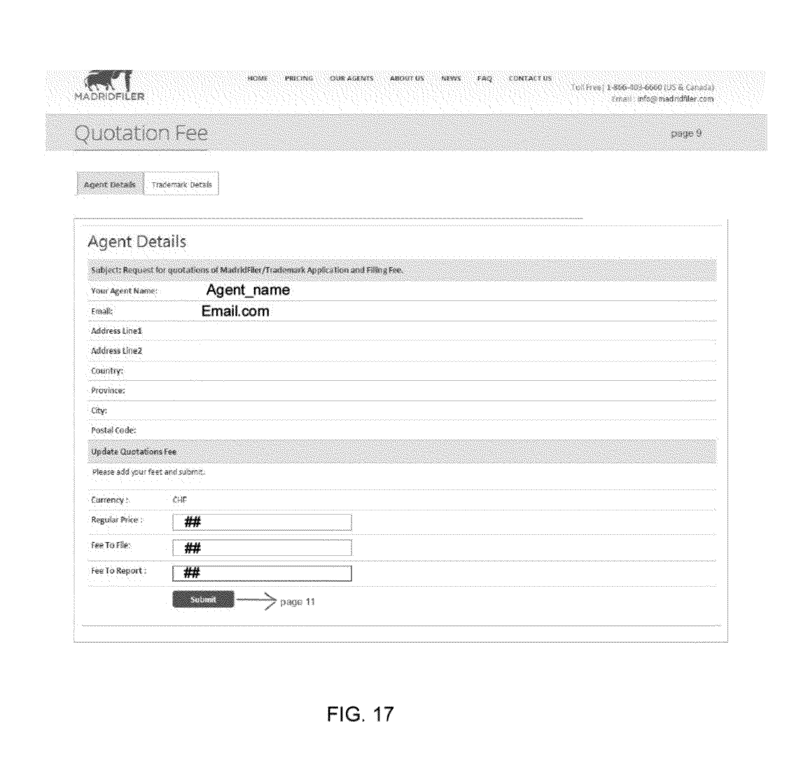

The following interface screens illustrate how the agents submit their quotations upon receipt of a request from the system. In the present example, the system automatically generates an email to the selected agent once the owner/user has submitted an order, such as from the screen of FIG. 9 or 11 by example. An example automated email to an agent is shown in FIG. 15A, which includes relevant information and a link to accept or decline the offer to submit a quotation. The selected agent then clicks a link in the email, which results in the system screen shown in FIG. 15B. The agent is given the option to either accept or decline the request to submit a quotation to the system. If the agent selects the decline option, then the system generates the screen shown in FIG. 16 and any further participation by the agent for this specific trademark serial number is terminated, and the system is configured to not expect a reply. Otherwise, the system generates the screen shown in FIG. 17 where the agent can input information, such as the quoted cost for the requested workproduct.

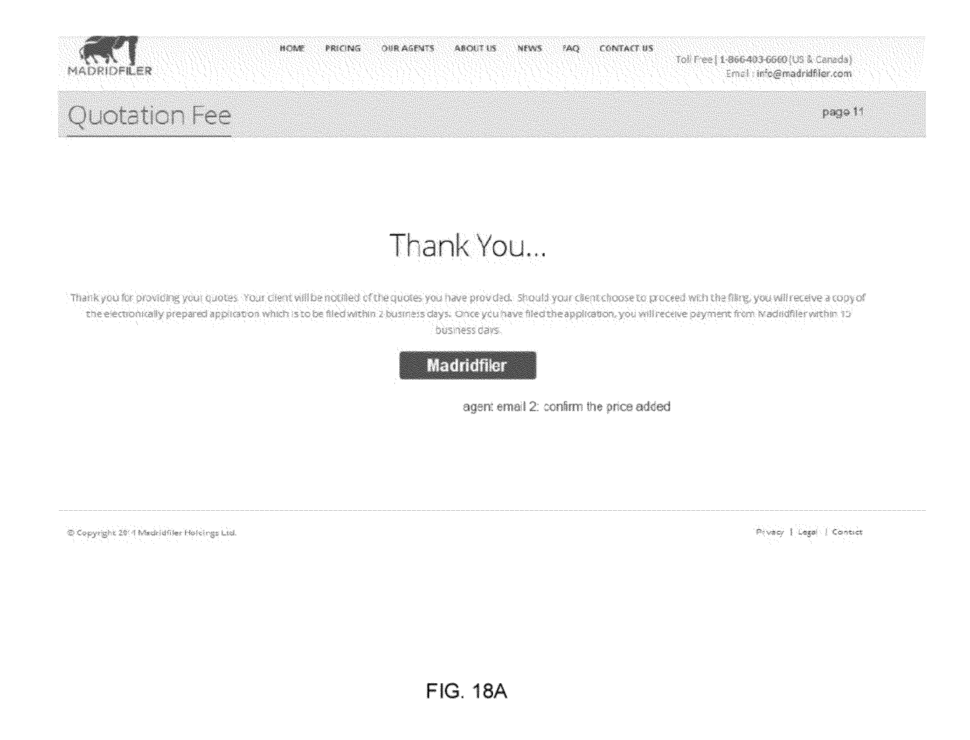

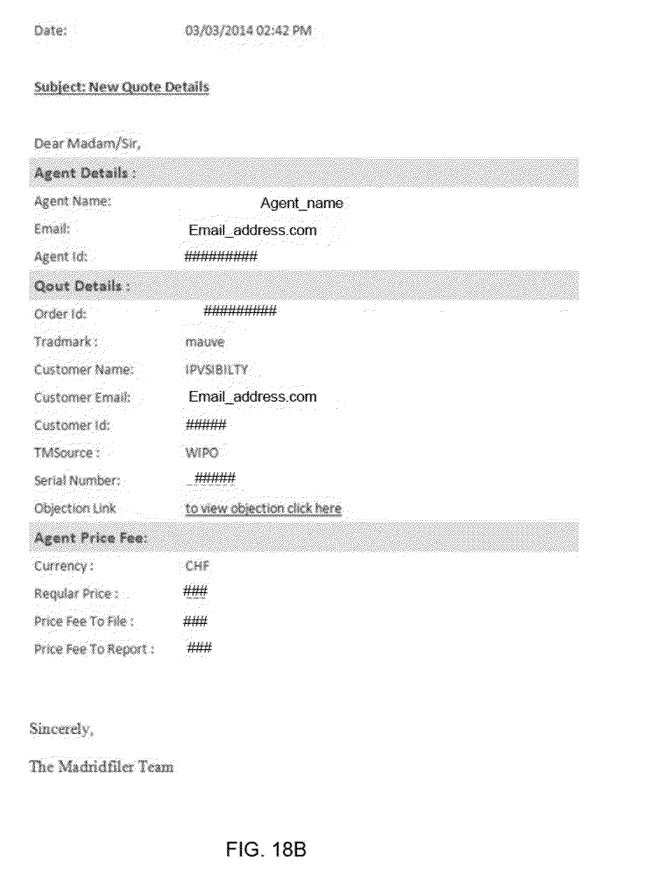

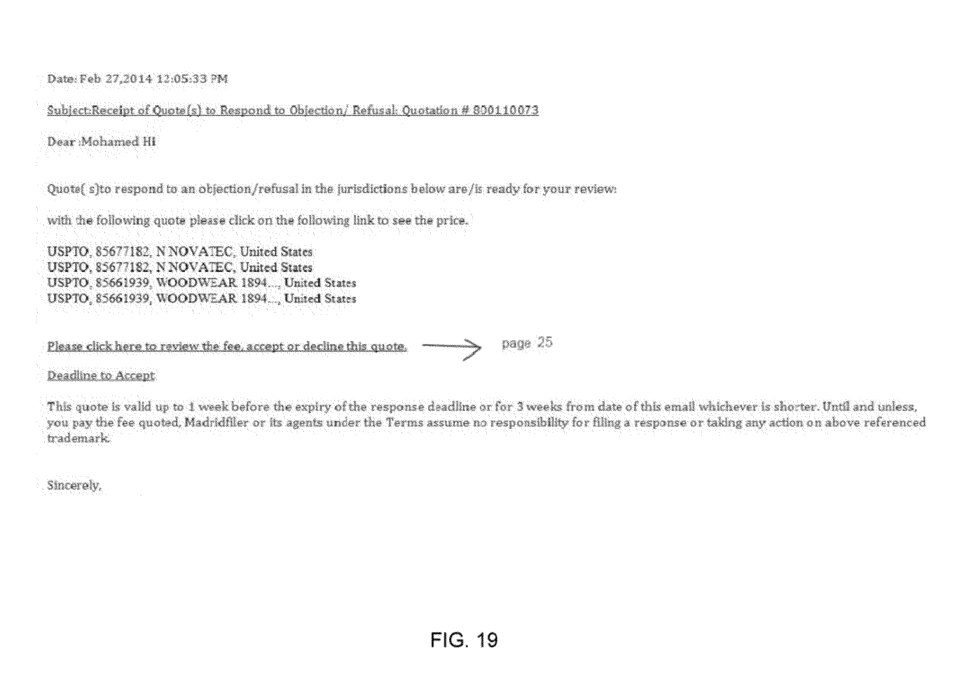

Once the agent has completed entry of the required information, the “submit” button is selected and the screen of FIG. 18A is automatically generated by the system to acknowledge its receipt of the agent's quotation and other relevant information. The system then automatically generates a summary of order details as shown in FIG. 18B, which is triggered after the thank you message is displayed for inputting pricing, and then sent to the system. The system may be programmed to wait 3-5 days, or any predetermined period of time, before sending one email back to the user computing system to advise that all the quotes are in. The system can be configured to ignore any quotes received after the predetermined time has expired. An example email automatically generated by the system for the owner/user is shown in FIG. 19.

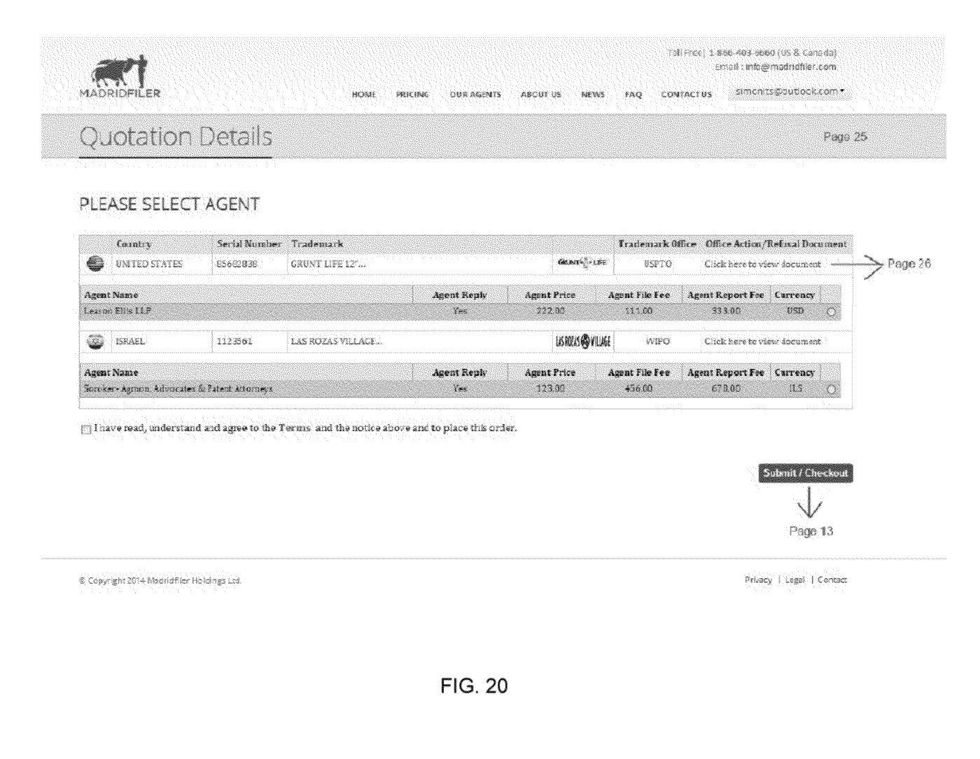

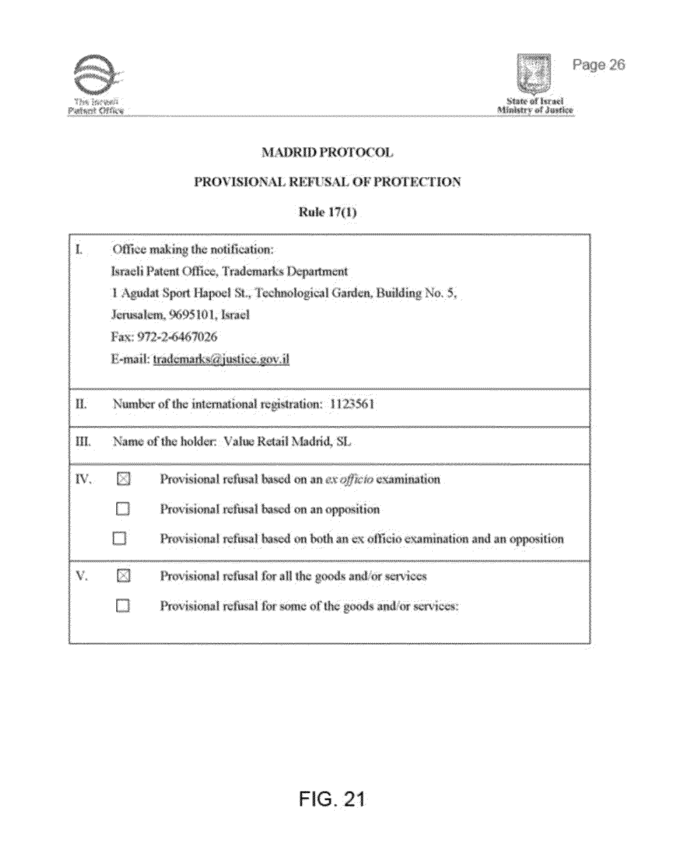

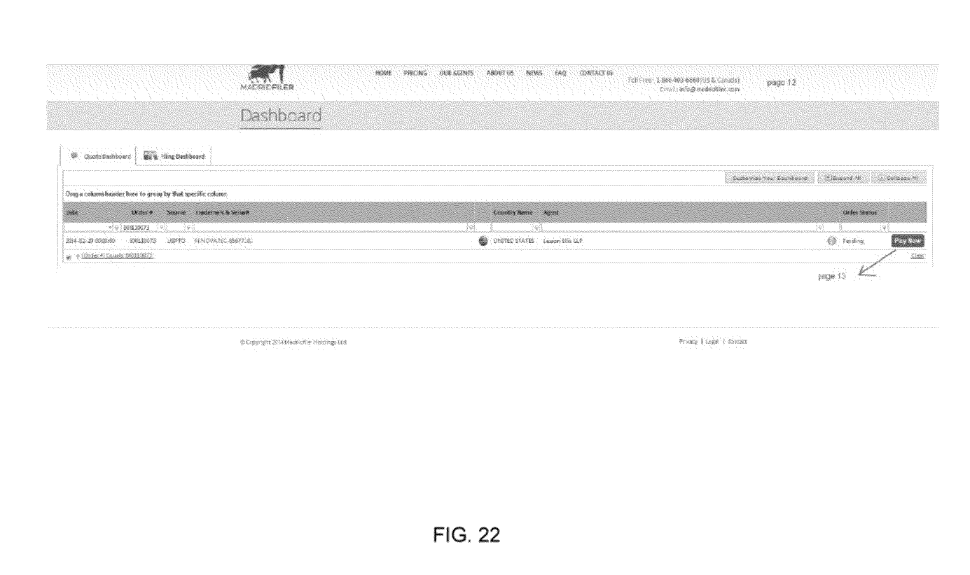

Upon receipt, the user/owner selects the automatically generated link, and the user/owner is shown the screen of FIG. 20 that lists all received quotes from different agents. From this screen, the user/owner can view the office action document, an example of which is shown in FIG. 21, and then select the agents to proceed with by tagging the selection button on the far right side of the row for the named agent. For informational status, the user/owner can select the status dashboard as shown by the screen of FIG. 22, which the user/owner can see all the submitted requests and the order number that is automatically generated for each request. This dashboard allows user/owners to see all their requests for quotation. It provides the following columns which can be sorted up and down, dragged and re-arranged.

Date column, time and date of initial order by user;

Order # column: an order number is generated by the system for any and all request made by users used to track activity;

Source column: the jurisdiction of the relevant trademark;

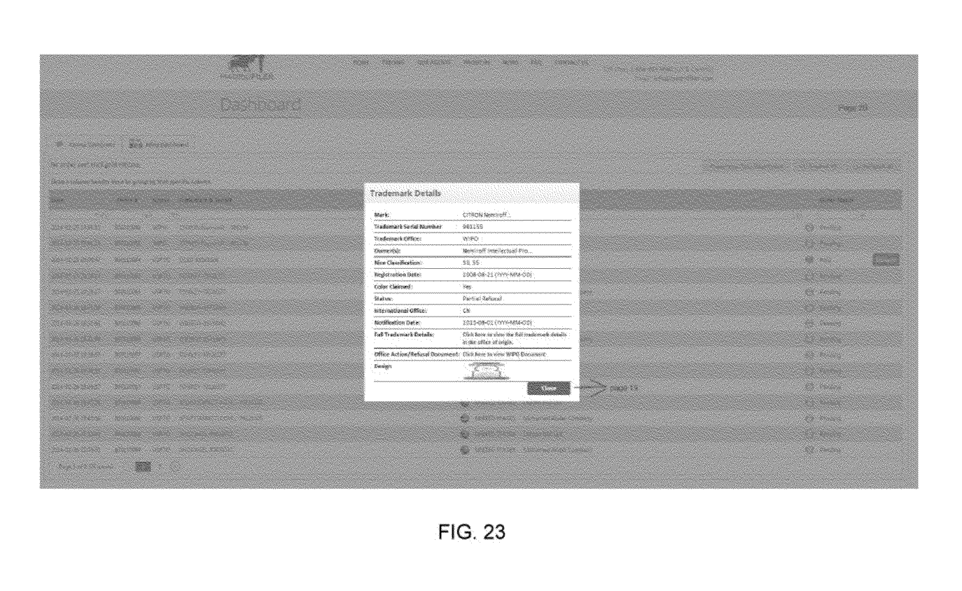

Trademark column—short description of the trademark, with a serial number and a link to the details of the specific trademark and objection, which when selected brings up the screen shown in FIG. 23;

Country name: For national trademarks, this is usually the country of the national IP office. However, where the source column is WIPO for instance, this will be the country in which there is a specific objection;

Agent: this will be the agent in the country for which the Office Action/Refusal requires a reply. Here there can be several agents showing up on this list for the same country and same trademark until the bid is accepted;

Order status: tells you where the order request is pending—meaning waiting for agent to reply or decline. Once agent replies, button changes to Pay and if client pays, changes to paid. accepted, a button appears indicates that it is ready;

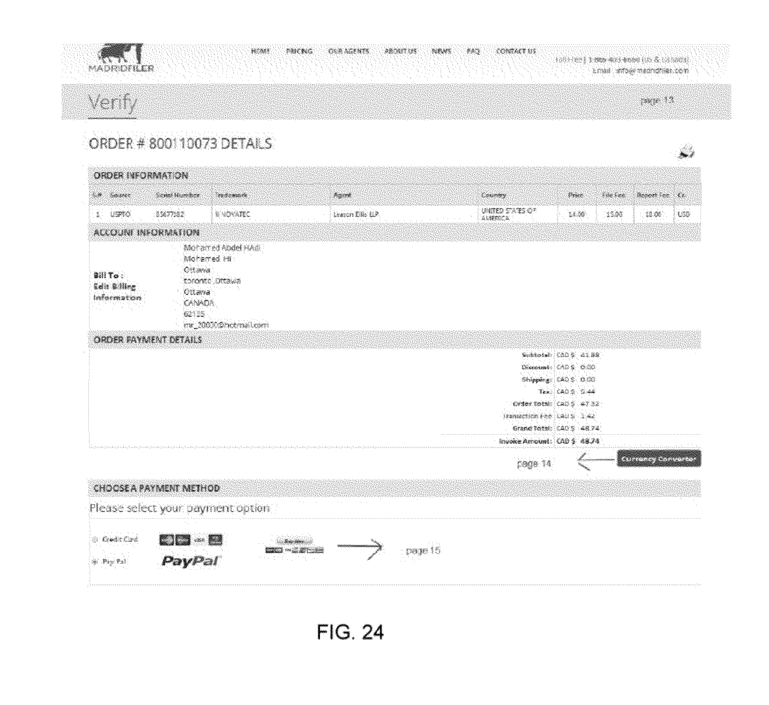

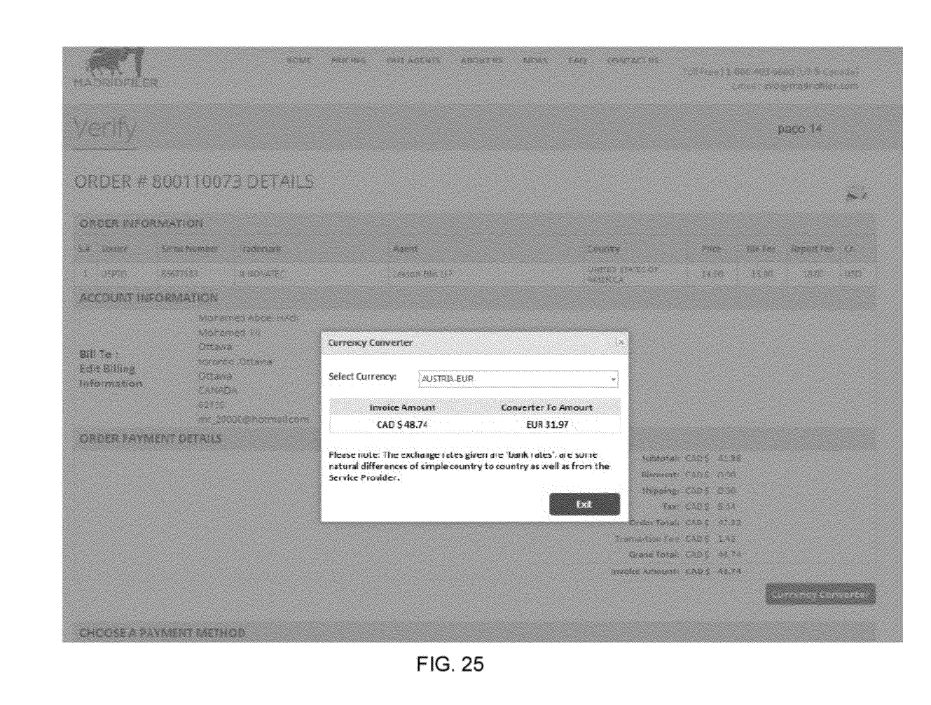

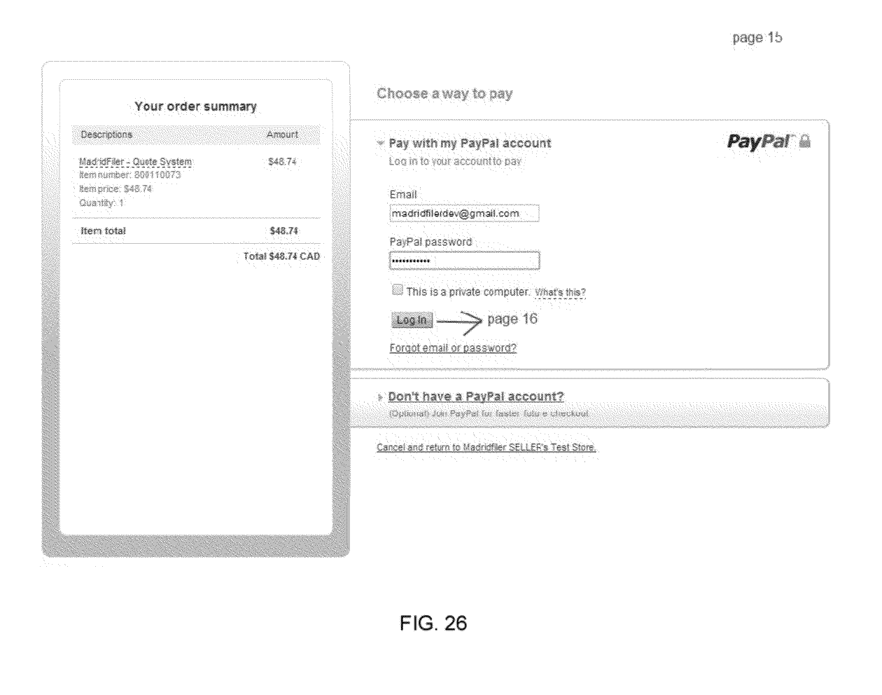

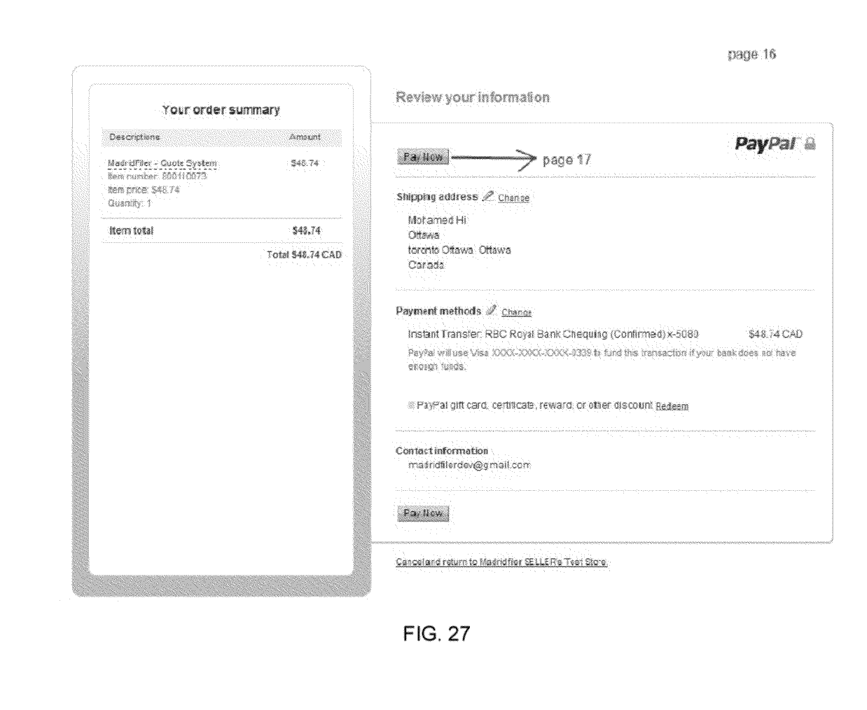

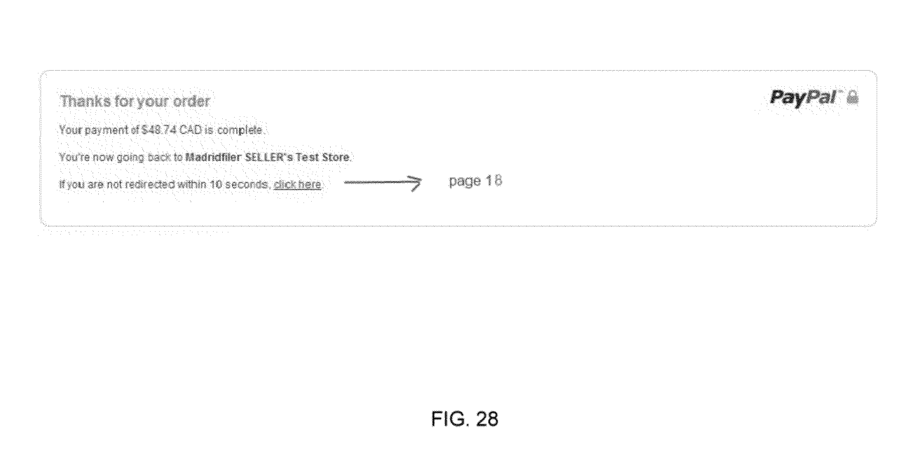

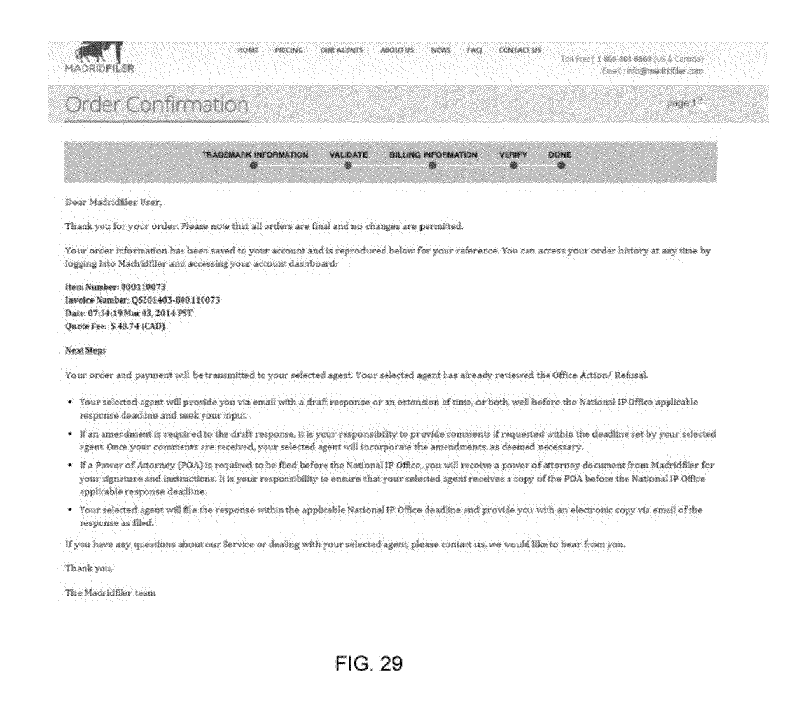

Returning to FIG. 20, once the user/owner hits the submit button after selecting at least one agent, they must provide payment information for each selected agent. The system generates the screen shown in FIG. 24, outlining billing information and the quoted cost. Given that the quotations may be provided in currencies that differ from what the user/owner is familiar with, the system has an integrated currency converter which is accessed by selecting the “Currency Converter” button. Selecting this generates the screen of FIG. 25, allowing for selection of the desired currency to convert the quotation to. Returning to FIG. 24, once a selection method is made, the system generates the screens of FIGS. 26 to 28 where payment details are entered and confirmed. This process is repeated for the other agents selected from the screen shown in FIG. 20. Once the payment process has been completed, the screen of FIG. 29 is generated by the system to inform the user/owner that the order has been completed.

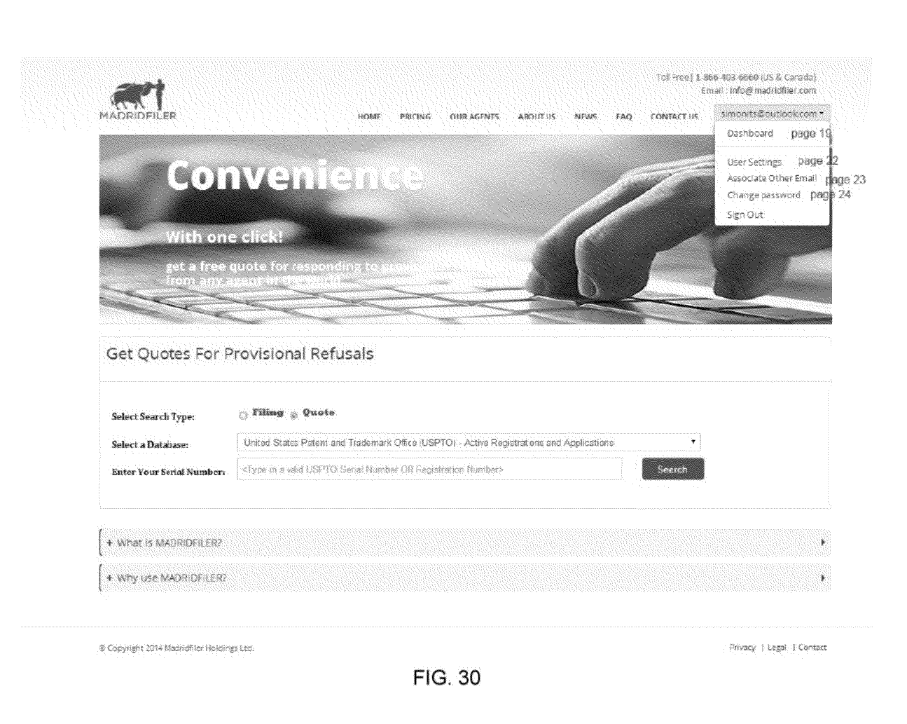

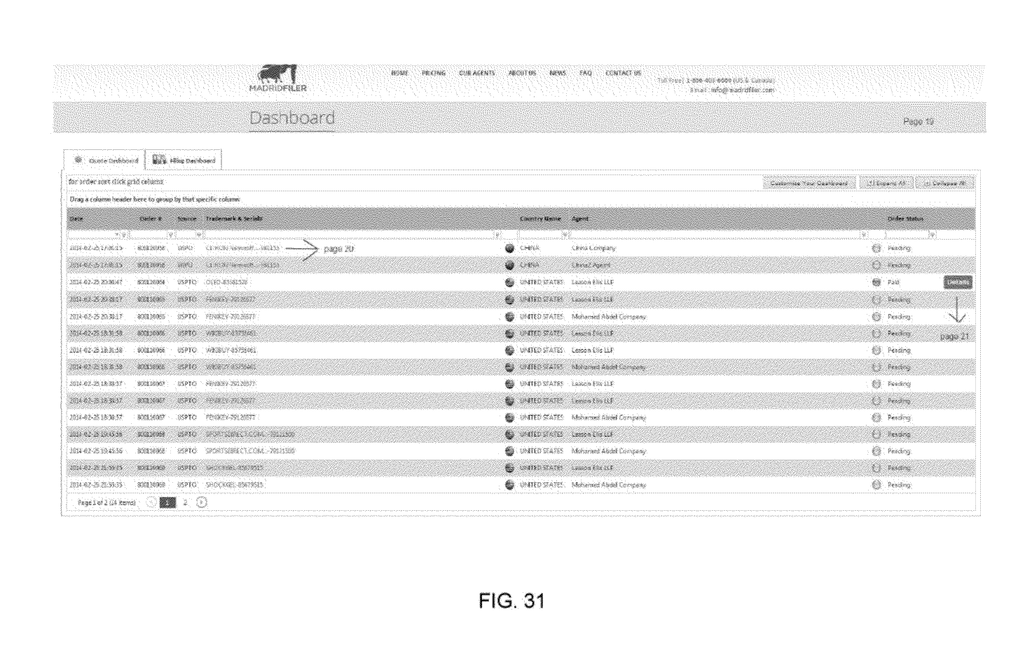

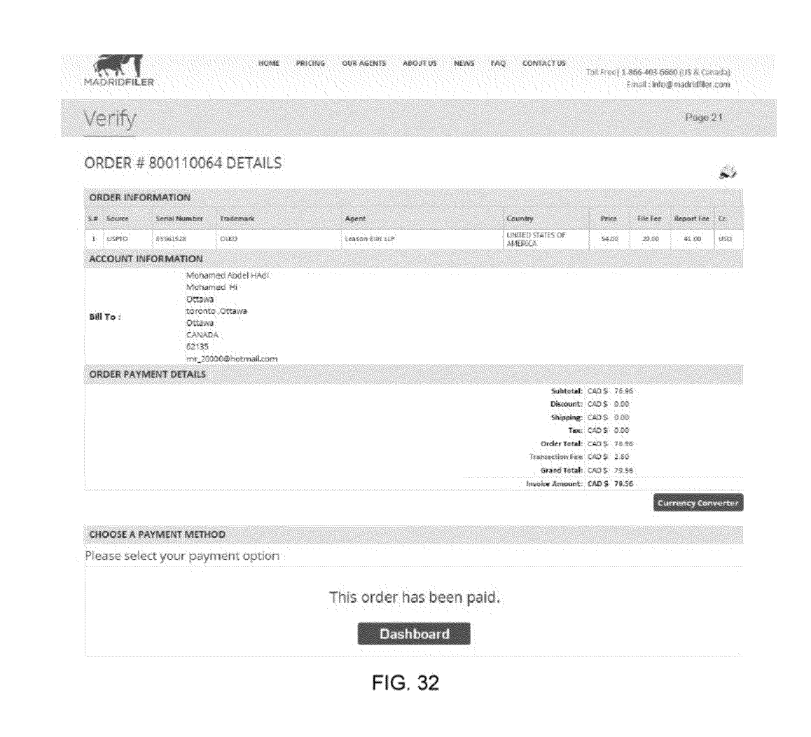

The following user interface screens show other examples of how the user/owner can check on the status of their orders. From the main interface screen of FIG. 30, the user/owner can select to view the “dashboard”, check associate emails and access other administrative activities. In selecting the dashboard, the system generates the summary shown in FIG. 31, which in the present example shows multiple orders with an order paid as shown in the third row. Once an order is attributed the “Paid” status by the system, an invoice is associated with the order, which can be viewed by selecting the “Details” button. A sample automatically generated invoice is shown in FIG. 32.

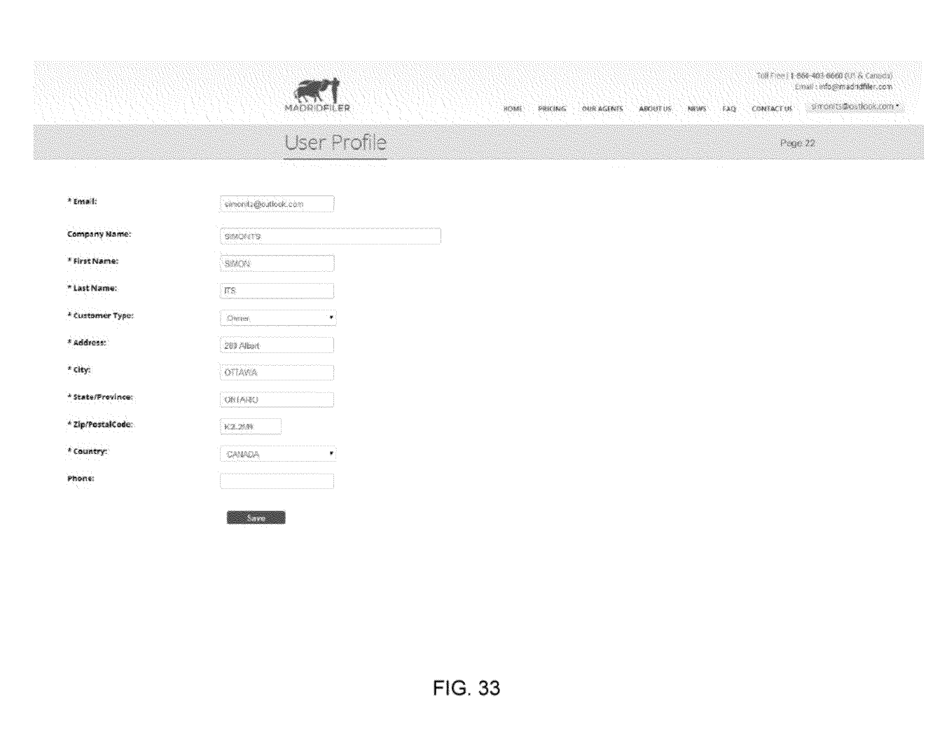

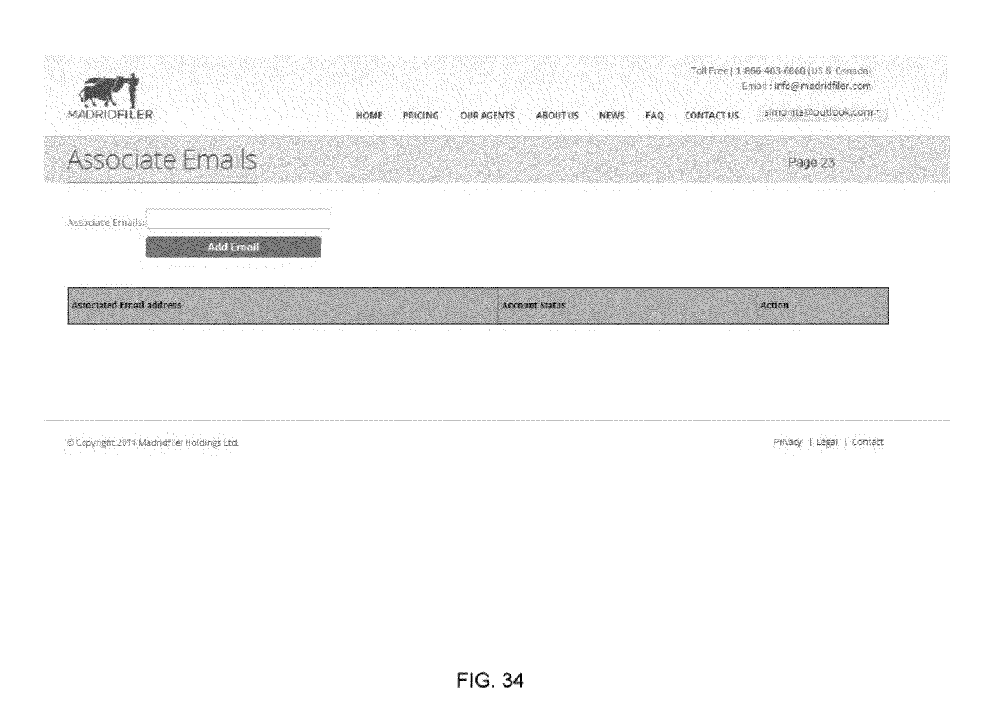

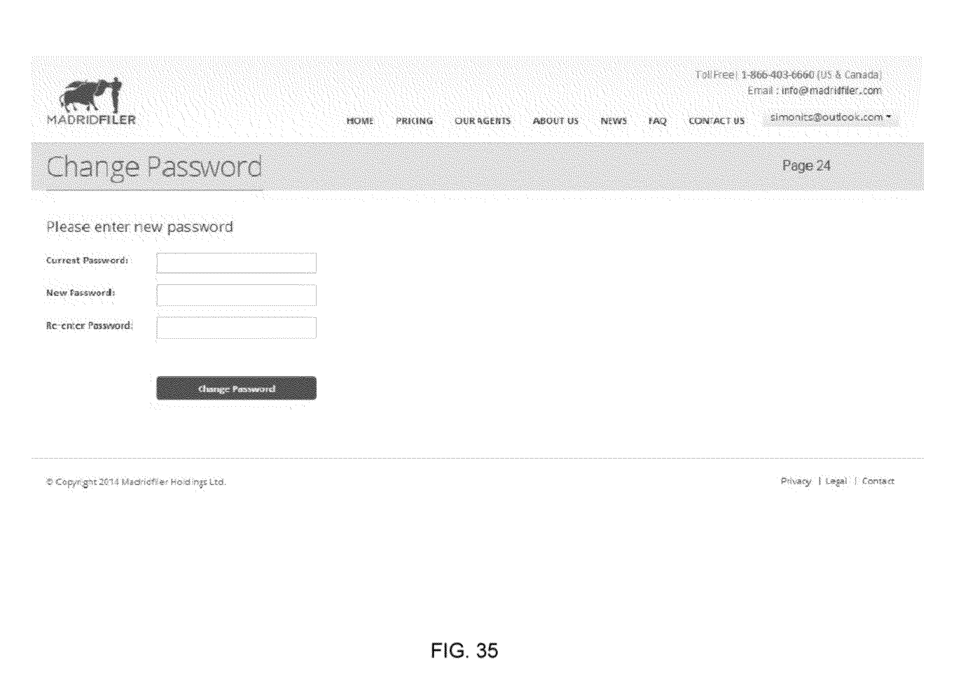

The system is configured to allow the user/owner control over some administrative functions. For example as shown in the interface screen of FIG. 33, the system allows the user/owner to adjust contact information, the interface screen of FIG. 34 allows the user/owner to add multiple associated email addresses for the system to send automatic notifications to, and the interface screen of FIG. 35 enables the user/owner to change their account password.

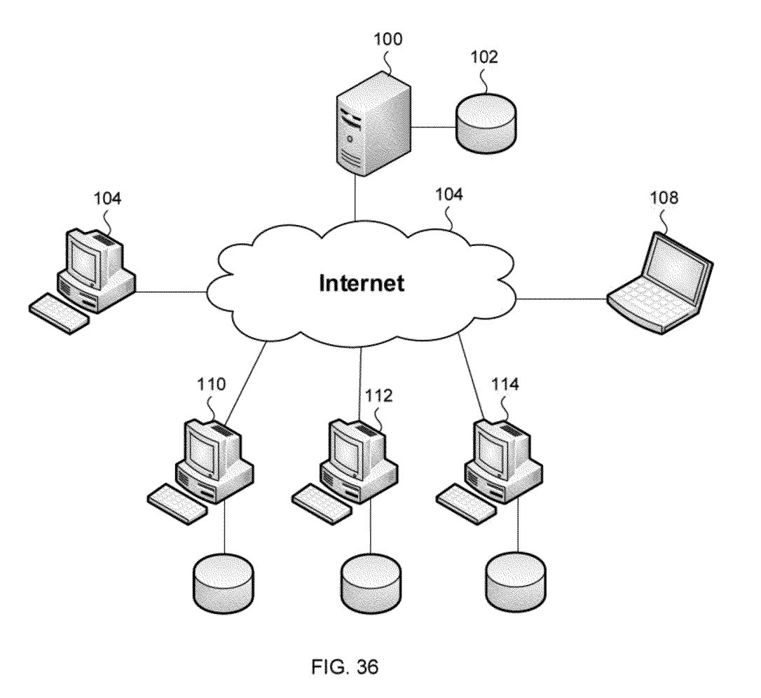

FIG. 36 is a network diagram showing the machines that the trademark workproduct quotation system communicates with. The trademark workproduct quotation system includes a host server 100 connected directly or indirectly to mass storage 102 and in communication with the internet 104. An owner/user computing system 106 is connected to the internet 104, as is an agent computing system 108. There can be any number of agent computing systems 108 connected to the internet, from different countries and/or the same countries. Also shown connected to the internet 104 are trademark data source computing systems 110, 112 and 114, each having respective mass storage. Each of the trademark data source computing systems can be associated with a specific country and stores data related to trademark applications of that country. Alternately, the trademark data source computing systems can be country independent sources. Computing systems 104, 108, 110, 112 and 114 have web interfaces to permit access to the internet, while computing systems 110, 112 and 114 have web interfaces permitting access to the stored information for extraction by the host server 100. The host server is configured to execute the functions shown in FIGS. 3A to 3C. More specifically, the host server 100 is configured to automatically access the appropriate data source computing systems 110, 112 and 114 over the internet and extract information that is copied to the host server database and stored on mass storage 102.

The various interface screens shown in the figures are displayed on either the computing systems 104 or 108, and information from the user/owner computing system 104 is provided to the host server 100, which is in turn processed such that further information is automatically provided by the host server 100 to the agent computing system 108. Similarly, information from the agent computing system 108 is provided to the host server 100, which is processed such that further information is automatically provided to the user/owner computing system 104.

In one embodiment, there is provided a machine generated system for communicating, via a processor, with other computers with data storage capacity and configured to receive IPT identifiers. The IPT identifiers are used to calculate and generate by way of mathematical formula deadlines related to Office Action/Refusals and thereafter display the deadlines. In addition, the system displays and delivers an electronic copy of an office action/refusal in a PDF document in two ways. First the display of the Office Action/Refusal document can relate to a single IPT in multiple countries or second, using a Master Unique Identifier display multiple IPTs that belong to one entity in multiple countries from one single computer generated interface.

In another embodiment, there is provided a machine generated system for communicating, via a processor, with other computers configured to receive and send IPT records for compiling and generating IPT statistics corresponding to information about specific office actions/refusals including types, difficulty and costs by country or jurisdiction.

In another embodiment, there is provided a machine generated system for communicating, via a processor, with other computers configured to receive and send IPT records for comparing and predicting pricing to respond to office actions/refusals by country, executing a set of computer executable instructions for price comparison and prediction, and applying the mathematical formula for price comparison and prediction, with a pre-defined bench mark corresponding to information about specific office actions/refusals including types, difficulty and costs for by country based on IPT statistics generated from a computer system.

The machine generated system including a computer system is configured to find, sort, analyze, synchronize and compare triggers consisting of pre-defined events in a data storage device with respect to an IPT or other identifiable item with respect to an IPT located in another configured computer system or computer systems. Each computer system features a separate and different IPTs broken down by jurisdiction. The machine generated system then joins each set of IPT records by jurisdiction synchronizes them in one computer system. Thereafter the results of the synchronized IPT records by jurisdiction are then displayed and to presented to the user with a computer executable instructions executed by a computing device. The presentation and display of the IPT records will include deadlines, user preferences, uniform resource locator addresses, documents, and a choice of countries and agents for the user's selection.

In another embodiment, there is provided a machine generated system for receiving from user and from a computing device basic user information by a computer system application server, wherein said basic IPT record is displayed such as the name, description, serial number, jurisdiction, office action/refusal document, linked to a computer set of instructions to display said document. To access and display such results, the user is not required to be an existing paying customer. The machine generated system with the assistance of a computer quote application system, displays a country or countries wherein the IPT or owner of IPT has office actions/refusals, the deadlines associated therewith, and presents to user all the said information and documents in one single interface. The computer quote application system's interface, shall comprise and display office actions/refusals, its associated deadlines by IPT and jurisdiction, choices of agents by jurisdiction, to whom or add to send instructions based on information received from user, the agent and country choices of the user. A user from its computer system can place a choice from the country choices comprising one or more agent choices for responding to an office action/refusal in identified country. The User's country agents choices, should include at least one IPT record, and one country and agent per country selection. Thereafter the entire set of such user choices and instructions are transmitted by the user's computer system to the computer quote application system.

In another embodiment, there is provided a machine generated system for communicating, via a processor, with other computers configured to generate, receive and send IPT record fixed costs information for responding to active office actions/objections or refusals in specific countries or jurisdictions.

In another embodiment, there is provided a machine generated system including a computer quote application system for generating instructions to agents setting out IPT information and specific office action/refusal information. The system can include a computer quote application system for sending instructions to an agent's computer system, the agent computer system in turn responds by sending agent answer and pricing to the computer quote application system to capture data input from agent factors and pricing. Thereafter, the computer system receives agent pricing, via processor, identifies agent's country other related elements associated with the agent and type of IPT factors. Once all elements are identified, the computer quote application system executes another set of computer executable instructions and determines price to respond to office action/refusal. Once the computer quote application system has determined price, via a processor, it sends a message responsive to user information to the user's computer system with specific prices and presents the pricing to the user. Using a computer quote application system interface, the user accepts or declines pricing. Once pricing accepted, computer quote system sends instructions to user's agent's choice computer system to proceed to respond to Office Action/Refusal.

In one aspect, the present invention provides a computer implemented method for generating a response to a trademark office action/refusal, comprising: receiving a serial number corresponding to a trademark application/registration from an owner computing system, and displaying on a display of the owner computing system all information and the office action/refusal corresponding to the serial number; displaying on the display a listing of agents who can prepare the response to the office action/refusal; receiving a selection of at least one agent from the owner computing system; automatically generating and issuing a request to at least one agent computing system of the at least one agent for a quotation to prepare the response; receiving at least one quotation from the at least one agent computing system, displaying on the display a listing of all received quotations from the at least one agent computing system; receiving a selection of one agent to prepare the response from the owner computing system; and issuing a request to one agent computing system corresponding to the one agent to proceed with preparing the response. In one aspect said step of receiving may include receiving a selection of one agent includes receiving payment information from the owner computing system.

In one aspect, the present invention provides a computer system for identification and notification of an office action/refusal document for an industrial property type (IPT), comprising: a host computing system configured to communicate electronically with at least one intellectual property source corresponding to different jurisdictions for extracting industrial property data for IPT applications, the host computing system being configured to cluster the industrial property data based on common identification information for the IPT applications; identify office action/refusal documents from the industrial property data; generate links between office action/refusal documents to one of the common identification information; calculate deadlines for each of the action/refusal documents; issue information relating to the office action/refusal documents, including at least a link or a copy of the office action/refusal documents, the deadlines and a list of agents who can respond to the office action/refusal documents, to a client computing device, and to receive agent selections from the client computing device; issue quotation requests to agent computing devices corresponding to selected agents received from the client computing device; and mass storage coupled to the host computing system for storing the industrial property data, the links, the deadlines, and the list of agents.

In one aspect, the present invention provides a method for automatically issuing work-product requests for responding to an office action, the method comprising: collecting office actions from multiple electronically-accessible sources into a database stored on a mass storage device for storing office action records, each office action record including: a sub-unique identifier, a master unique identifier, and a first jurisdiction identifier; processing the office actions into the office action records to be stored in the database by associating the office action record to a first application record with the sub-unique identifier, associating the first application record and the sub-unique identifier to a second application record of another jurisdiction related to the first application record with the master unique identifier, and associating the office action record and the first application record to a jurisdiction with the first jurisdiction identifier; calculating a due date for each office action record based on a mailing date of each office action record and based on a response period of the jurisdiction associated to each office action record, and associating each due date to each office action record stored in the database; collecting agent records into the database, each agent record including a second jurisdiction identifier for identifying the jurisdiction in which an agent of the agent record is authorized to respond to the office action; automatically determining the agent records having the second jurisdiction identifier matching the first jurisdiction identifier of the selected office action record, in response to receiving a signal corresponding to selection of the office action record in the database; generating a list of work-product requests corresponding to the automatically determined agent records for the selected office action record; issuing the work-product request to each of the automatically determined agent records for the selected office action record; and deleting the office action record from the mass storage device and removing the office action record associations with the first application record, the jurisdiction, and the due date in the database, when a current date is past the calculated due date, in order to conserve data storage space on the mass storage device.

In one aspect, the invention provides a computer system for automatically issuing work product requests for responding to an office action, the system comprising: a database for storing office action records and agent records, each office action record including: a sub-unique identifier, a master unique identifier, and a first jurisdiction identifier, and each agent record including a second jurisdiction identifier for identifying the jurisdiction in which an agent of the agent record is authorized to respond to the office action; a data acquisition engine for collecting office actions from multiple electronically-accessible sources, processing the office actions into the office action records to be stored in the database by associating the office action record to a first application record with the sub-unique identifier, associating the first application record and the sub-unique identifier to a second application record of another jurisdiction related to the first application record with the master unique identifier, and associating the office action record and the first application record to a jurisdiction with the first jurisdiction identifier, calculating a due date for each office action record based on a mailing date of each office action record and based on a response period of the jurisdiction associated to each office action record, and associating each due date to each office action record stored in the database; a search engine configured to: receive the selection of an office action record, retrieve the selected office action record from the database, and determine the agent records having the second jurisdiction identifier matching the first jurisdiction identifier of the retrieved office action record; a request generator for generating a list of work-product requests corresponding to the determined agent records; a request issuer for sending the work-product request to email addresses corresponding to each of the determined agent records for the retrieved office action record; and a garbage collector for deleting the office action record from the mass storage device and removing the office action record associations with the first application record, the jurisdiction, and the due date in the database, when a current date is past the calculated due date, in order to conserve data storage space on the mass storage device.

In one aspect, the present invention provides a computer system user interface for automatically generating a list of work product requests for responding to an office action, comprising: a database back-end for storing office action records and agent records, each office action record including: a sub-unique identifier, a master unique identifier, and a first jurisdiction identifier, the sub-unique identifier for associating the office action record to a first application record, the master unique identifier for associating the first application record and the sub-unique identifier to a second application record of another jurisdiction related to the first application record, and the first jurisdiction identifier for associating the office action record and the first application record to a jurisdiction, and each agent record comprising a second jurisdiction identifier for identifying the jurisdiction in which an agent of the agent record is authorized to respond to the office action, the database configured to: calculate a due date for each office action record based on a mailing date of each office action record and based on a response period of the jurisdiction associated to each office action record, and associate each due date to each office action record stored in the database, and delete the office action record from the mass storage device and remove the office action record associations with the first application record, the jurisdiction, and the due date in the database, when a current date is past the calculated due date, in order to conserve data storage space on the mass storage device; and a user interface front-end comprising: a search form to receive a user input from an input device of the user interface, the user input comprising the sub-unique identifier, the master identifier, or the first jurisdiction identifier of an office action record, and a display to graphically present, automatically in response to the user input, a list of agent records having the second jurisdiction identifier matching the first jurisdiction identifier of the office action record corresponding to the sub-unique identifier of the user input.

What is claimed is:

1. A system for providing a user module at least one quote for responding to an intellectual property (IP)-related deadline, said system comprising a service module, the service module comprising:
a data acquisition engine configured to communicate electronically with an IP office computer system in at least one jurisdiction and to automatically identify and extract IP-related information from said IP office computer system for multiple IP documents, wherein said IP-related information includes jurisdiction, serial number, and deadline-generating dates, and wherein said data acquisition engine automatically generates links to electronically accessible IP office correspondence having a reply deadline;
a database clustering engine for processing the extracted IP-related information, said clustering engine
automatically generating a sub-unique identifier to associate an IP document with a serial number,
automatically generating an IP jurisdiction identifier to associate the IP document with a jurisdiction,
automatically associate deadline-generating dates with the sub-unique identifier and the IP jurisdiction identifier for the corresponding IP document, and
automatically associate a link to electronically accessible IP office correspondence having a reply deadline with the sub-unique identifier and the IP jurisdiction identifier for the corresponding IP document,
a set of statements and instructions for deadline calculation, based on deadline-generating dates and jurisdiction associated therewith;
a processor configured to:
automatically execute said set of statements and instructions to calculate an upcoming deadline for each of said deadline-generating dates,
automatically associate said deadline to said IP document and to said corresponding sub-unique identifier and jurisdiction identifier, and
automatically determine the agent records having the agent jurisdiction identifier matching the IP jurisdiction identifier of said IP document, to generate a list of one or more agents in said jurisdiction;
a mass storage device for storing a database comprising:
said IP-related information,
said deadlines,
said links to IP office correspondence having a reply deadline, each IP office correspondence having a reply deadline being associated with (i) the sub-unique identifier, and (ii) the IP jurisdiction identifier, and
agent records, each agent record including (iii) an agent jurisdiction identifier to identify the agent's jurisdiction;
a search engine configured to:
receive an input from said user module,
in response to said input, automatically retrieve the IP-related information, the link to IP office correspondence having a reply deadline, and said corresponding deadline(s), associated with one or more corresponding sub-unique identifiers, and
automatically retrieve the generated list of one or more agents in said jurisdiction corresponding to said agent jurisdiction identifiers;
communication means, configured to communicate electronically with one or more agent modules and a user module, the communication means configured to:
in response to said input, automatically display on the user module, the IP-related information, the deadlines, and the link to IP office correspondence having a reply deadline, retrieved by the search engine, and said deadline(s) calculated by the processor, and
automatically display on the user module, the generated list of one or more agents in said jurisdiction,
receive a selection of a deadline from a user module,
a request generator, for automatically compiling a request for a quote, said request comprising the deadline and any link to the IP office correspondence having a reply deadline;
said communication means further configured to:
automatically provide agent modules with said request for a quote, said agent modules corresponding to the list of one or more agents in said jurisdiction,
receive a resulting quote from the agent module(s),
automatically provide said quote(s) to said user module,
receive an agent selection from the user module, and
in response to said agent selection, automatically provide the selected agent with instructions to respond to the IP office deadline.

2. The system of claim 1, wherein the database clustering engine further automatically generates a master unique identifier to associate the serial number of the IP document with the serial number of a related second IP document of another jurisdiction, for grouping members of an IP family.

3. The system of claim 1, said communication means further configured to receive, from said user module, information corresponding to additional agents in said jurisdiction.

4. The system of claim 1, further comprising:
a garbage collector for deleting said deadlines, said links to said IP office correspondence having a reply deadline, and said associations between the IP office correspondence having a reply deadline and both the serial number and jurisdiction, when a current date is past the calculated deadline, in order to conserve storage space on the mass storage device.

5. The system of claim 1, further comprising a text crawler, configured to automatically:
extract relevant headings and/or relevant legal provisions from said IP office correspondence having a reply deadline, and
generate a summary of said IP office correspondence having a reply deadline, said summary configured to be displayed on said display of said user module.

6. The system of claim 1, wherein said input is a serial number selection.

7. The system of claim 1, wherein said database clustering engine automatically generates an owner and/or applicant identifier for associating the IP document with the corresponding owner and/or applicant,
wherein the search engine is configured to receive an owner and/or applicant name input from a user module, and
wherein in response to receipt of said owner and/or applicant name input, the service module automatically displays on the user module, a list of IP documents having said owner and/or applicant, the IP-related information, the link to IP office correspondence having a reply deadline, and said corresponding deadline(s), retrieved by the search engine.

8. The system of claim 1, wherein said IP-related information further includes one or more selected from the group consisting of: owner, applicant, trademark, title, IP document, agent, correspondent, filing date, priority date, class, service and wares, postal addresses, IP document record, and links thereto.

9. A method for automatically transmitting instructions to an agent module to respond to an IP office deadline selected by a user module, said method comprising:
automatically identifying and extracting IP-related information from an IP office computer system for multiple IP documents, wherein said IP-related information includes jurisdiction, serial number, and deadline-generating dates;
automatically generating links to electronically accessible IP office correspondence having a reply deadline;
processing and clustering the extracted IP-related information, by automatically generating a sub-unique identifier to associate an electronically accessible IP office correspondence having a reply deadline with the serial number of a corresponding IP document, and automatically generating an IP jurisdiction identifier to associate the IP office correspondence having a reply deadline with the jurisdiction of the corresponding IP document;
storing said IP-related information; said deadlines; and said links to IP office correspondence having a reply deadline on a storage device, each IP office correspondence having a reply deadline being associated with (i) the sub-unique identifier, and (ii) the IP jurisdiction identifier; agent records, each agent record including (iii) an agent jurisdiction identifier to identify the agent's jurisdiction;
automatically executing a set of computer executable statements and instructions to calculate a deadline for each of said deadline-generating dates;
automatically associating said deadline to said IP office correspondence having a reply deadline and to said corresponding sub-unique identifier;
automatically determining the agent records having the agent jurisdiction identifier matching the IP jurisdiction identifier of said IP office correspondence having a reply deadline, to generate a list of one or more agents in said jurisdiction;
in response to an input from the user module, automatically retrieving the IP-related information, the link to IP office correspondence having a reply deadline, and said corresponding deadline(s), associated with one or more corresponding sub-unique identifiers, and automatically retrieving the generated list of one or more agents in said jurisdiction corresponding to said agent jurisdiction identifiers;
in response to said input from the user module, automatically displaying on a display of the user module, the IP-related information, the link to IP office correspondence having a reply deadline, and said corresponding deadline(s),
in response to said input from the user module, automatically displaying on the display of a user module, the generated list of one or more agents in said jurisdiction,
receiving a selection of an IP office correspondence having a reply deadline from the user module,
automatically compiling a request for a quote, said request comprising the deadline and the link to the IP office correspondence having a reply deadline;
automatically transmitting to agent modules with said request for a quote, said agent modules corresponding to the list of one or more agents in said jurisdiction;
receiving a resulting quote from the agent module(s), and automatically provide said quote(s) to said user module,
receiving an agent selection from the user module, and in response to said agent selection, automatically providing the selected agent with instructions to respond to said deadline.

10. The method of claim 9, further comprising automatically generating a master unique identifier to associate the serial number of the IP document with the serial number of a related second IP document of another jurisdiction, for grouping members of an IP family, and storing said master unique identifiers on the storage device.

11. The method of claim 9, further comprising receiving from said user module, information corresponding to additional agents in said jurisdiction.

12. The method of claim 9, further comprising deleting said deadlines, said links to said IP office correspondence having a reply deadline, and said associations between the IP office correspondence having a reply deadline and both the serial number and jurisdiction from the storage device, when a current date is past the calculated deadline, in order to conserve storage space.

13. The method of claim 9, further comprising:
extracting relevant headings and/or relevant legal provisions from said IP office correspondence having a reply deadline, and
generating a summary of said IP office correspondence having a reply deadline, said summary configured to be displayed on said display of said user module.

14. The method of claim 9, wherein said input is a serial number selection.

15. The method of claim 9, further comprising automatically generating an owner and/or applicant identifier for associating the IP document with the corresponding owner and/or applicant,
receiving an owner and/or applicant name input from a user module, and
wherein in response to receipt of said owner and/or applicant name input, automatically displaying on the user module, a list of IP documents having said owner and/or applicant, the IP-related information, the link to IP office correspondence having a reply deadline, and said corresponding deadline(s), retrieved by the search engine.

16. The method of claim 9, wherein said IP-related information further includes one or more selected from the group consisting of: owner, applicant, trademark, title, IP document, agent, correspondent, class, service and wares, postal addresses, IP document record, and links thereto.
